(19) United States
(12) Patent Application Publication
(10) Pub. No.: US 2022/0150732 A1
(43) Pub. Date: May 12, 2022

(54) Radio Communications System and Method

(71) Applicant: Hitachi, Ltd., Tokyo (JP)

(72) Inventor: Ken TAKEI, Tokyo (JP)

(21) Appl. No.: 17/453,699

(22) Filed: Nov. 5, 2021

(30) Foreign Application Priority Data
Nov. 6, 2020 (JP) 2020-185682

(51) Int. Cl. H04W 24/06; G01S 7/00; G01S 13/00; G01S 13/86

(52) U.S. Cl. CPC H04W 24/06; G01S 13/86; G01S 13/003; G01S 7/006

(57) ABSTRACT

A problem to solve is ensuring communication stability in a service area. One example of a preferable embodiment of the invention is a radio communications method adapted to control physical characteristics of electromagnetic waves that are transmitted by radio units. The radio communications method comprises the following: creating an electromagnetic field model for presuming a communication environment in a service area where the radio units exist by using information on positions and dimensions of objects in the service area; presuming communication characteristics of the radio units through the electromagnetic field model; and modifying the physical characteristics based on the communication characteristics and carrying out communication.

### BACKGROUND

The present invention pertains to a radio communications system in which transmission of information using electromagnetic waves takes place in a radio wave environment such that radio scatterers exist in a service area and relates to a radio communications system adapted to stabilize communication characteristics of radio units constituting a radio system when there is variation of the radio wave environment of a service area.

With global dissemination of mobile wireless terminals for information communication, there is an increasing demand to enjoy radio communications services such as radio telephony and radio data transfer without being concerned about a surrounding environment. When radio scatterers exist in an area where radio communications services are offered, radio waves scattered by the scatterers affect electromagnetic waves as the medium of radio communications and power of electromagnetic waves radiated from a transmitter undergoes variation until having arrived at a receiver; in most cases, this brings about a decrease in received power. Decrease in received power results in deterioration in communication quality and makes it hard to ensure stability of communication. In order to solve this problem, a technical approach is proposed in which radio units constituting a radio system are installed in a service area, taking account of effects of radio scatterers in the service area beforehand.

Japanese Unexamined Patent Application Publication No. 2015-080061 describes a technical approach that creates a model for computing electromagnetic waves in a service area, based on provided placement data on where radio scatterers are placed in a service area (the data including their position, shape, and material). The approach computes an electromagnetic field distribution through that model with multiple radio units being placed in the service area and determines locations where the radio units should be placed so that radio system performance that is determined depending on communication conditions of the radio units becomes optimal.

### SUMMARY

The foregoing technical approach of prior art is effective, supposing that a radio wave environment does not vary in a radio communication service area. Nevertheless, current radio systems are such that radio scatterers or wireless terminals move in a service area. Consequently, the radio wave environment varies in a radio communication service area and, therefore, it is not guaranteed realistically to attain optimal performance of radio communication. There has been posed a problem of difficulty in ensuring communication stability.

The present application includes several means for solving the foregoing problem. One preferred aspect thereof resides in a radio communications method adapted to control physical characteristics of electromagnetic waves that are transmitted by radio units. The radio communications method comprises the following: creating an electromagnetic field model for presuming a communication environment in a service area where the radio units exist by using information on positions and dimensions of objects in the service area; presuming communication characteristics of the radio units through the electromagnetic field model; and modifying the physical characteristics based on the communication characteristics and carrying out communication.

Another preferred aspect of the present invention resides in a system comprising multiple radio units for communication and a controller. The controller comprises the following: a radio unit position storage unit to store the positions of the radio units for communication; a measurement data storage unit to store measurement data relevant to change in positions and dimensions of objects in a service area where the radio units for communication exist; a structural object data storage unit in which structural object data has been stored with regard to information on positions and dimensions of objects in the service area where the radio units for communication exist; a radio wave environment computation unit that creates a model for computing a radio wave environment in the service area, based on the positions of the radio units for communication, the measurement data, and the structural object data; and a physical parameter computation unit that computes physical parameters so that the radio wave environment approximates to a predetermined target value, based on the radio wave environment. The controller transmits the physical parameters to the radio units for communication and the radio units for communication modifies transmission conditions based on the received physical parameters.

To give one example of more specific means, in a radio system comprising multiple radio units for measurement and radio units for communication and a controller, the radio units for measurement detect objects in a service area of the radio system, measure information on the objects, and transmit that information to the controller. Multiple transmitters of the radio units for communication perform information communication with physical parameters of electromagnetic waves that are specific to each radio unit and used for transmission/reception and transmit information on radio unit's communication quality to the controller. The controller retains information on placement and properties of structural objects in the service area and information on placement of the radio units for communication. The controller reads in information from the radio units for measurement. By using this information as well as the retained information on placement and properties of structural objects and the retained information on placement of the radio units for communication, the controller creates an electromagnetic field model for computing a communication environment in the service area. Through the electromagnetic field model, the controller presumes communication quality of the radio units for communication that perform communication in the service area. The controller reads in information on communication quality from the radio units for communication and stores and accumulates that information. By comparing the presumed communication quality against the stored communication quality, the controller determines a combination of physical parameters that the radio units for communication should use and by which difference between both indexes of communication quality will decrease through the electromagnetic field model. The controller transmits the combination of physical parameters to the radio units and each of the radio units for communication performs communication between them using the applicable physical parameters of electromagnetic waves.

To give another example that is more specific, in a radio system comprising multiple radio units for measurement and radio units for communication and a controller, the radio units for measurement detect objects in a service area of the radio system, measure information on the objects, and transmit that information to the controller. The transmitters of the radio units for communication perform information communication between them with physical parameters of electromagnetic waves that they use for transmission/reception and are specific to each of them and transmit information on their communication quality to the controller. The controller retains information on placement and properties of structural objects in the service area and information on placement of the radio units for communication. The controller reads in information from the radio units for measurement. By using this information as well as the retained information on placement and properties of structural objects and the retained information on placement of the radio units for communication, the controller creates an electromagnetic field model for computing a communication environment in the service area. Through the electromagnetic field model, the controller computes an electromagnetic field distribution in the service area and stores and accumulates the computed electromagnetic field distribution. Through the electromagnetic field model, the controller determines a combination of physical parameters that the radio units for communication should use and by which variation in the electromagnetic field distribution that is serially accumulated on the time axis will decrease. The controller transmits the combination of physical parameters to the radio units and each of the radio units for communication performs communication between them using the applicable physical parameters of electromagnetic waves.

To give yet another specific example, in a radio system comprising multiple radio units for communication and a controller, the radio units for communication perform information communication with physical parameters of electromagnetic waves that are specific to each radio unit and used for transmission/reception in a service area of the radio system and transmit information on radio unit's communication quality to the controller. The controller retains information on placement and properties of structural objects in the service area and information on placement of the radio units for communication. By using the retained information on placement and properties of structural objects and the retained information on placement of the radio units for communication, the controller creates an electromagnetic field model for computing a communication environment in the service area. Through the electromagnetic field model, the controller presumes communication quality of the radio units for communication that perform communication in the service area. The controller stores and accumulates information on communication quality read in from the radio units for communication. By comparing the presumed communication quality against the stored communication quality, the controller determines a combination of physical parameters that the radio units for communication should use and by which difference between both indexes of communication quality will decrease through the electromagnetic field model. The controller transmits the combination of physical parameters to the radio units and each of the radio units for communication performs communication using the applicable physical parameters of electromagnetic waves.

To give yet another specific example, in a radio system comprising multiple radio units for measurement and radio units for communication, a controller, and a server that provides a platform, the radio units for measurement detect objects in a service area of the radio system, measure information on the objects, and transmit that information to the controller. The transmitters of the radio units for communication perform information communication with physical parameters of electromagnetic waves that are specific to each radio unit and used for transmission/reception and transmit information on radio unit's communication quality to the controller. The controller retains information on placement and properties of structural objects in the service area and information on placement of the radio units for communication. The controller reads in information from the radio units for measurement. By using this information as well as the retained information on placement and properties of structural objects, the controller creates a radio wave environment model for computing a communication environment in the service area. The controller inputs the radio wave environment model to the platform in the server, creates radio unit placement data by using information on placement of the radio units for communication, and inputs the radio unit placement data to the platform in the server. The controller reads in information from the radio units for communication, creates communication quality data from that information, and inputs the communication quality information to the platform in the server. The platform creates an electromagnetic field model for computing an electromagnetic field distribution in the service area by using the radio wave environment model and the radio unit placement data that have been input thereto. Through the electromagnetic field model, the platform presumes communication quality of the radio units for communication that perform communication in the service area. The platform reads in information on communication quality from the radio units for communication and stores and accumulates that information. By comparing the presumed communication quality against the stored communication quality, the platform determines a combination of physical parameters that the radio units for communication should use and by which difference between both indexes of communication quality will decrease through the electromagnetic field model and outputs the combination of physical parameters to the controller as control parameters. The controller converts the control parameters input thereto to individual physical parameters of electromagnetic waves that the radio units for communication use and transmit the physical parameters to the radio units. Each of the radio units for communication performs communication using the applicable physical parameters of electromagnetic waves.

To give yet another specific example, in a radio system comprising multiple radio units for communication using rotating polarization, a controller, and a server that provides a platform, the radio units for communication measure a polarization angle of transmit and receive polarizations during rotating polarization communication between a pair of radio units in a service area of the radio system and transmit data on the thus measured polarization data to the controller. The transmitters of the radio units for communication perform information communication with physical parameters of electromagnetic waves that are specific to each radio unit and used for transmission/reception and transmit information on radio unit's communication quality to the controller. The controller reads in polarization data, computes polarization shifts for all pairs of the radio units in the service area, and inputs the polarization shifts to the platform in the server. The controller creates radio unit placement data by using information on placement of the radio units for communication and inputs the radio unit placement data to the platform in the server. The controller reads in information from the radio units for communication, creates communication quality data from that information, and inputs the communication quality information to the platform in the server. The platform creates a rotating polarization environment model for computing a rotating polarization radio wave environment in the service area by using the polarization shifts and the radio unit placement data that have been input thereto. Through the rotating polarization environment model, the platform presumes communication quality of the radio units for communication using rotating polarization that perform communication in the service area. The platform reads in information on communication quality from the radio units for communication and stores and accumulates that information. By comparing the presumed communication quality against the stored communication quality, the platform determines a combination of physical parameters that the radio units for communication using rotating polarization should use and by which difference between both indexes of communication quality will decrease through the rotating polarization environment model and outputs the combination of physical parameters to the controller as control parameters. The controller converts the control parameters input thereto to individual physical parameters of electromagnetic waves that the radio units for communication use and transmit the physical parameters to the radio units. Each of the radio units for communication performs communication using the applicable physical parameters of electromagnetic waves.

According to the present invention, it would become possible to stabilize communication quality of a radio system and provide communications services at high quality.

### BRIEF DESCRIPTION OF THE DRAWINGS

FIG. 1A is a block diagram of a configuration of a radio system embodiment.

FIG. 1B is a transparent perspective view of an IoT communication system using a radio system embodiment.

FIG. 2A is a flowchart to explain operation of a controller in a radio system embodiment.

FIG. 2B is a flowchart to explain operation of a radio unit for communication in a radio system embodiment.

FIG. 3 is a ladder chart to explain operation timing in a radio system embodiment.

FIG. 4 is a block diagram of another configuration of a radio system embodiment.

FIG. 5A is a flowchart to explain operation of a controller in another radio system embodiment.

FIG. 5B is a flowchart to explain operation of a radio unit for communication in another radio system embodiment.

FIG. 6 is a ladder chart to explain operation timing in another radio system embodiment.

FIG. 7 is a block diagram of another configuration of a radio system embodiment.

FIG. 8 is a block diagram of another configuration of a radio system embodiment.

FIG. 9 is a block diagram of another configuration of a radio system embodiment.

FIG. 10 is a block diagram of another configuration of a radio system embodiment.

FIG. 11 is a block diagram of another configuration of a radio system embodiment.

FIG. 12 is a block diagram of another configuration of a radio system embodiment.

FIG. 13 is a block diagram of another configuration of a radio system embodiment.

FIG. 14A is a flowchart to explain operation of a controller in another radio system embodiment.

FIG. 14B is a flowchart to explain operation of a platform in another radio system embodiment.

FIG. 15 is a ladder chart to explain operation timing in another radio system embodiment.

FIG. 16 is a block diagram of another configuration of a radio system embodiment.

FIG. 17A is a flowchart to explain operation of a controller in another radio system embodiment.

FIG. 17B is a flowchart to explain operation of a platform in another radio system embodiment.

FIG. 18 is a ladder chart to explain operation timing in another radio system embodiment.

FIG. 19 is a circuitry diagram of an embodiment of the transmitter of a radio unit for communication in a radio system.

FIG. 20 is another circuitry diagram of an embodiment of the transmitter of a radio unit for communication in a radio system.

FIG. 21 is another circuitry diagram of an embodiment of the transmitter of a radio unit for communication in a radio system.

FIG. 22 is another circuitry diagram of an embodiment of the transmitter of a radio unit for communication in a radio system.

FIG. 23 is another circuitry diagram of an embodiment of the transmitter of a radio unit for communication in a radio system.

FIG. 24 is another circuitry diagram of an embodiment of the transmitter of a radio unit for communication in a radio system.

FIG. 25 is a transparent perspective view of an IoT communication system using another radio system embodiment.

FIG. 26 is a transparent perspective view of an IoT communication system using another radio system embodiment.

FIG. 27 is a transparent perspective view of an IoT communication system using another radio system embodiment.

### DETAILED DESCRIPTION

In the following, embodiments are described with the aid of the drawings. However, the present invention should not be construed to be limited to the following descriptions of embodiments. Those skilled in the art will easily appreciate that a concrete configuration of the present invention may be modified without departing from the idea or spirit of the invention.

In a configuration of an embodiment which will be described hereinafter, to identify identical components or components having a like function, identical reference numerals are used in common across different drawings, and duplicated description may be omitted.

When there are multiple elements having an identical or like function, they may be identified by an identical reference numeral with different subscripts in a description regarding them. However, when it is not necessary to individualize those multiple elements, the subscripts may be omitted in a description regarding them.

Notation of “first”, “second”, “third”, etc. herein is prefixed to identify components, but it is not necessarily intended to confine the components to a certain number, sequence, or contents. Besides, numbers to identify components are used a per-context basis; a number used in one context does not always denote the same component in another context. Additionally, it is not precluded that a component identified by a number also functions as a component identified by another number.

In some cases, the position, size, shape, range, etc. of each component depicted in a drawing or the like may not represent its actual position, size, shape, range, etc. with the intention to facilitate understanding of the invention. Hence, the present invention is not necessarily to be limited to a certain position, size, shape, range, etc. disclosed in a drawing or the like.

Publications, patents and patent applications cited herein constitute as such a part of the description herein.

Components mentioned herein in singular form may be taken in plural form, unless otherwise specified explicitly in a context.

### First Embodiment

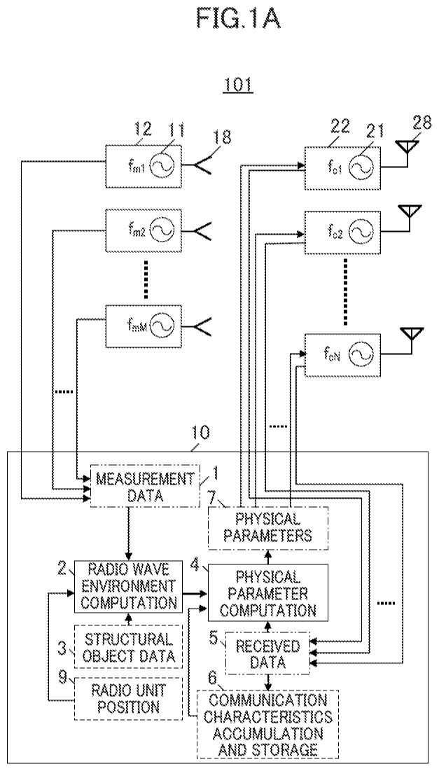

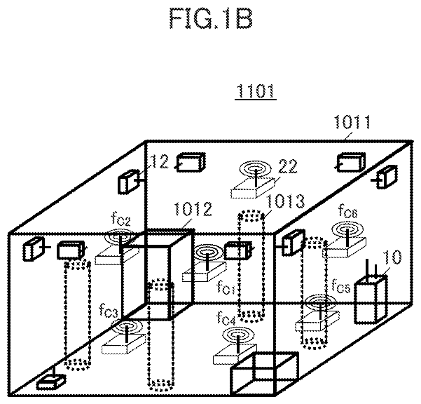

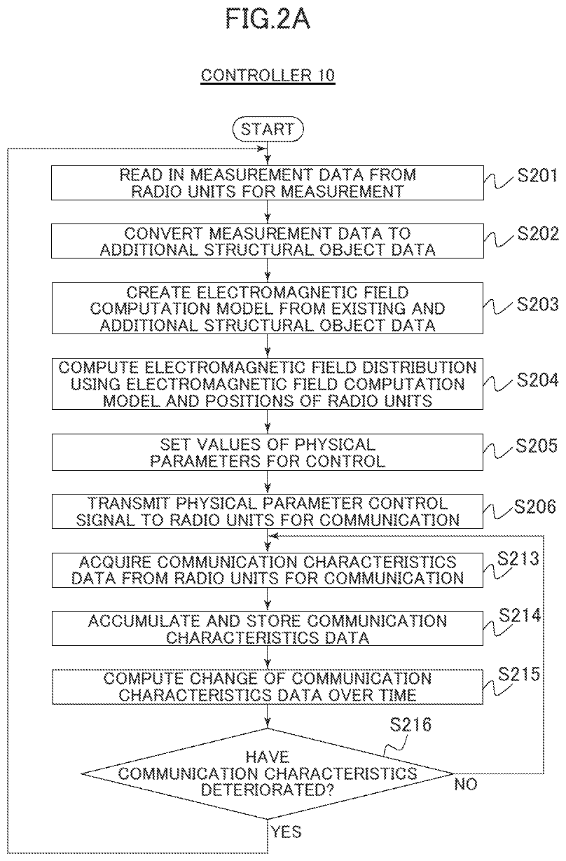

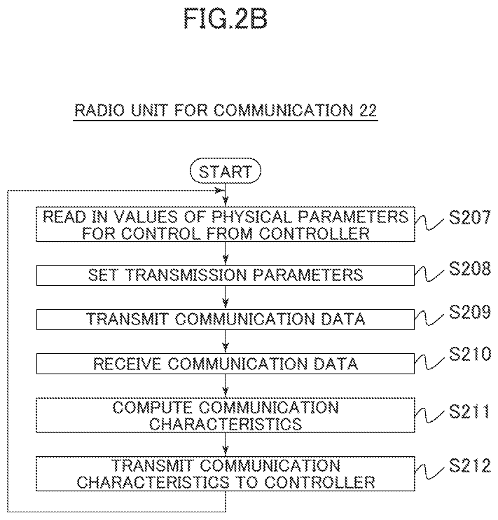

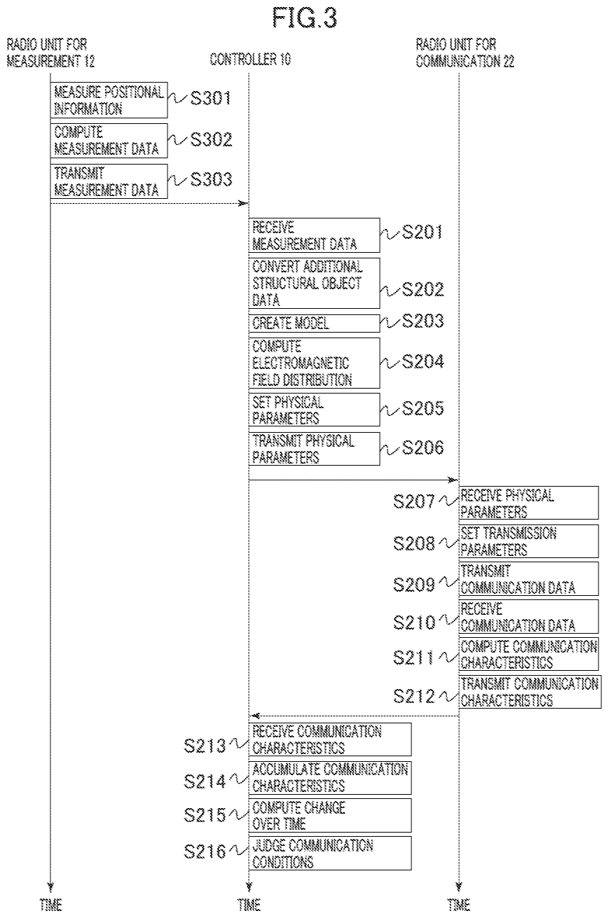

With FIGS. 1A, 1B, 2A, 2B, and 3, descriptions are provided of an example of a radio system adapted to stabilize communication quality when the radio communication environment changes. FIG. 1A is a diagram to explain a configuration of the radio system adapted to stabilize communication quality when the radio communication environment changes. FIG. 1B is a transparent perspective view of an Internet of Things (IoT) communications system that utilizes this radio system. FIGS. 2A and 2B are flowcharts to explain operation of the radio system; FIG. 2A illustrates an operation flow of a controller 10 and FIG. 2B illustrates an operation flow of each unit of equipment. FIG. 3 is a diagram to explain operation timing of each unit of equipment.

In FIG. 1A, the radio system 101 according to an embodiment is comprised of multiple radio units 12 for measurement, multiple radio units 22 for communication, and a controller 10 that transfers and receives data to/from each of the radio units 12 for measurement and the radio units 22 for communication. Data transfer between each of the radio units 12 for measurement and the radio units 22 for communication 22 and the controller 10 may be performed by wire or radio. In the first embodiment, data transfer is assumed to be performed by wire, as indicated by arrowed solid lines in FIG. 1A.

For the radio units 12 for measurement, a carrier frequency for measurement is denoted by fₘᵢ. For the radio units 22 for communication, a carrier frequency for communication is denoted by f_{ci}. The radio units 12 for measurement transmit and receive a signal for measurement by radio. The radio units 22 for communication perform typical data transmission and reception by radio.

As the radio units 22 for communication, communication devices for data transmission and reception based on one of various protocols and standards which are publicly known can be used. There are no particular restrictions on communication protocols that may be used.

The radio units 12 for measurement detect the position of an object on the principle of radar. As is well known, radar measures the distance and direction to a physical object by emitting radio waves toward the object and measuring reflected waves from it. Because the radio units 12 for measurement need to detect the position, shape, posture, etc. of an irregularly moving object, their carrier frequency fₘᵢ for measurement should commonly be higher than the carrier frequency f_{ci} of the radio units 22 for communication for typical data transmission. As an example of the carrier frequency fmi, it is realistic to use a wavelength that is a negligible length ( 1/10 or less, conventionally) as compared with wavelength that is used for communication; i.e., a frequency that is one order or more of magnitude higher than the carrier frequency for communication.

A concrete example of the carrier frequency fₘᵢ for communication of the radio units 12 for measurement is 28 GHz which is one of frequency bands that are used for 5G (the 5th Generation Mobile Communications System) and one order of magnitude higher than the communication frequency for 5G ranging between several hundreds of MHz and several GHz. Additionally, single chip implementation of hardware is feasible and this enables it to reduce the radio unit manufacturing cost. A 60-70 GHz band can be used as millimeter wave frequencies for radar and detection accuracy improvement can be expected, but its practical use has a problem in terms of the radio unit manufacturing cost and authentication cost. Supposing that infrared (IR) frequencies are used, the radio unit manufacturing cost can be reduced, because both an IR transmitter device and receiver device are small in size and less costly. Nevertheless, because IR frequency wavelength is short, communication distance is limited to a range of several meters and, therefore, a large number of radio units for measurement have to be installed within the system. In the present embodiment, the frequency of and the number of the radio units 12 for measurement to be installed are selectable according to application and purpose.

FIG. 1B is an example of a configuration diagram of an IoT radio monitoring system that applies the radio system of FIG. 1A. The radio monitoring system 1101 of the present embodiment is equipped with multiple radio units 12 for measurement and multiple radio units 22 for communication inside a building 1011 in which multiple stationary structural objects 1012 and mobile objects 1013 exist.

In the IoT radio monitoring system, for example, a radio unit 22 for communication transmits image data of status inside the building 1011 captured by a camera to another radio unit 22 for communication (or the controller 10 and a concentrated base station provided separately (which is not depicted)). The controller 10 and the concentrated base station are connected to, e.g., an external terminal over a network, thus enabling it to monitor the status from outside via the controller 10 and the concentrated base station. Besides camera images, data corresponding to sound, heat, etc. sensed by various sensors can be monitored. Also, in the IoT radio monitoring system, a radio unit 22 for communication can transmit necessary data and commands to another radio unit 22 for communication.

The preset embodiment enables it to restrain variation of the radio wave environment caused by movement of physical entities in the radio wave environment within a communication service area by modifying physical parameters regarding transmission of multiple radio units 22 for communication comprised in the radio system. This provides an advantageous effect for stabilizing communication performance of the radio monitoring system.

An example of modifying physical parameters is modifying, e.g., a subcarrier frequency distribution. Physical parameters for transmission to be modified are selectable according to application and standards of the radio units 22 for communication. For example, modifying the carrier frequency f_{ci} can be expected to produce a significant effect, though hardware becomes complicated. It is also effective to modify the plane of polarization of carrier radio waves and a configuration for doing so is easy to provide. It is also effective to modify transmission power, provided that there are no legal restrictions. Antenna directivity is also modifiable and configuring a radio unit to be equipped with multiple antennas makes it easy to modify directivity. Particularly, modifying the plane of polarization and directivity is better in practical terms, since a configuration for doing so is easy to provide and, generally, there are less legal restrictions. In the present embodiment, one or a combination of optional physical parameters may be modified.

In FIG. 1A, each radio unit 12 for measurement is equipped with its carrier frequency generator 11 and an antenna 18 for measurement. Each radio unit 22 for communication is equipped with its carrier frequency generator 21 and an antenna 28 for communication.

In FIG. 1A, the controller 10 can be configured by using, e.g., a commonly used server having a communication function. As with commonly used servers, the controller 10 includes an input device, an output device, a processing device, and a storage device. FIG. 1A depicts functional blocks, omitting components with which a server is typically equipped. Among the functional blocks, a component block drawn with a dashed line means a depository of static data (a database), an element block drawn with a dashed-dotted line means a depository of data that is updated over time (e.g., a cache memory), and a component block drawn with a solid line means a process. In the present embodiment, functions, inter alia, for computing and control of each process are implemented in such a manner that a program stored in the storage device is executed by the processing device to perform prescribed processing in cooperation with other hardware. Programs that a computer or the like executes, their functions, or means for implementing the functions may be referred to as: “functions”, “means”, “sections”, “units”, “modules”, etc. Also, data of all sorts is stored in the storage device configured by using a magnetic disk device, a semiconductor memory, etc. A part of the storage device to store data may be referred to as a “storage unit”.

The controller configured as above may be built on a single server or any subset of the input device, the output device, the processing device, and the storage device may be built on any other computer connected to the controller via a network. Note that software implemented functions and their equivalents in the present embodiment can also be implemented by hardware such as Field Programmable Gate Array (FPGA), Application Specific Integrated Circuit (ASIC), etc.

The controller 10 is equipped with a measurement data storage unit 1 and reads in and stores measurement data from the radio units 12 for measurement into this unit. Measurement data is data that reflects the position and shape of an object in a service area or change in the position and shape thereof. The controller 10 is equipped with a received data storage unit 5 and reads in and stores data that has been received from the radio units 22 for communication and pertain to their conditions of communication into this unit. The controller also accumulates the same data contents into a communication characteristic accumulation and storage unit 6 in a time-series manner. Data pertaining to communication conditions is, for example, received signal strength of a radio unit or its related error rate and signal-to-noise ratio; an optional selection may be made of any data by which communication quality of the radio units 22 for communication can be evaluated. In the first embodiment, explanations are made assuming that such data is received signal strength that is the most fundamental.

The controller 10 also stores information of the positions of the radio units 22 for communication in the service area into a radio unit position storage unit 9. The controller also stores information of the position, shape, and material of a structural object 1012 in the service area into a structural object data storage unit 3. The contents of the structural object data storage unit 3 and the radio unit position storage unit 9 should be recorded in a database (DB) form in an optional manner before system operation. Because structural objects 1012 and radio units 22 for communication are static objects usually, the DB contents do not change basically. However, when a change has been made to the structural objects 1012 or the radio units 22 for communication have been relocated, the contents of the structural object data storage unit 3 or the radio unit position storage unit 9 should be updated at that time.

A radio wave environment computation unit 2 computes a radio wave environment based on measurement data and structural object data. A physical parameter computation unit 4 computes physical parameters that the radio units 22 for communication use for transmission. A physical parameter storage unit 7 stores physical parameters that will be transmitted to the radio units 22 for communication.

Operation of the present radio system 101 is described with FIGS. 1A, 2A, and 3. In the first embodiment, processing steps S213 through S216 should be regarded as a processing loop that is run routinely. Based on data received from the radio units 22 for communication, the controller acquires communication characteristics data (S213), accumulates and stores that data into the communication characteristic accumulation and storage unit 6 (S214), computes change of communication characteristics data over time (S215), and decides whether or not the communication characteristics have deteriorated, inter alia, by comparison against a threshold. The controller iterates this processing periodically and monitors communication conditions of the radio units 22 for communication. If the characteristics have been deteriorated, the controller proceeds to modifying physical parameters.

Each radio unit 12 for measurement measures the distance and direction to a physical object such as structural objects 1012 and mobile objects 1013 by emitting radio waves toward the object and measuring reflected waves from it (FIG. 3, S301). From thus obtained positional information, the radio unit computes measurement data representing the shapes and the positions of structural objects 1012 and mobile objects 103 (S302) and transmits the measurement data to the controller 10 (S303). While, in the first embodiment, acquiring measurement data is to be initiated depending on the branch decision at the step 5216, acquiring measurement data may be performed routinely.

The controller 10 receives measurement data from the radio units 12 for measurement and stores that data into the measurement data storage unit 1 (S201).

Then, the radio wave environment computation unit 2 converts the stored measurement data to additional structural object data (S202). The radio units 12 for measurement transmit measurement data without discriminating between stationary and mobile objects. Therefore, the radio wave environment computation unit 2 computes difference between the measurement data and data existing in the structural object data storage unit 3 and obtains additional structural object data. Measurement data is obtained in accordance with a system of coordinates specified relative to each unit 12 for measurement as a basis. Therefore, the measurement data is converted to data on common coordinate axes by using data of the positions of the radio units existing in the radio unit position storage unit 9.

Besides, by using the contents of the measurement data storage unit 1, the radio unit position storage unit 9, and the structural object data storage unit 3, the radio wave environment computation unit 2 creates an electromagnetic field computation model for computing an electromagnetic field distribution in the service area (S203).

In the system of the present embodiment, it is required to build a communication environment in a cyber space. When doing so, static objects contained in the structural object data storage unit 3, including walls, ceiling, floor, furniture, etc. have a high volume ratio occupying the space for communication and their data to be accumulated in the cyber space becomes huger as compared with mobile objects. Therefore, in creating an electromagnetic field computation model, it is preferable to solely update additional structural object data on mobile objects, but not to update existing structural object data on static objects.

Then, the radio wave environment computation unit 2 computes an electromagnetic field distribution (S204) by using the electromagnetic field computation model and the positions of the radio units and, as necessary, data on transmission output and directivity distributions among the radio units 22 for communication. Model creation and an algorithm of computing a radio field intensity distribution are disclosed in Japanese Unexamined Patent Application Publication No. 2015-080061.

In addition, the radio wave environment computation unit 2 presumes communication conditions of each radio unit 22 for communication through the created electromagnetic field computation model (S204). Indication of communication conditions to be presumed is, for example, received signal strength (electric field strength in the position of each radio unit for communication) based on the electromagnetic field distribution. Alternatively, a computation is made of delay spreading (difference in delay between each wave resulting from separation of multiple electromagnetic waves that arrive at or around a receiving point). Besides, a signal-to-noise ratio or error rate may be presumed by a function approximator such as a Deep Neural Network (DNN) learned with teacher data in which an electromagnetic field distribution is given as a problem and communication conditions as a correct answer. In the first embodiment, it is assumed that the radio wave environment computation unit 2 presumes received signal strength.

Then, the latest communication conditions of the radio units for communication being stored in the received data storage unit 5, past communication conditions of the radio units for communication being stored in the communication characteristic accumulation and storage unit 6, and presumed communication conditions are input to the physical parameter computation unit 4. Using these pieces of information, a decision is made as to whether or not it is necessary to update physical parameters of electromagnetic waves that each radio unit for communication uses for communication and, if necessary, the physical parameters are updated (S205).

As an concrete example, in comparison against the latest communication conditions of the radio units for communication being stored in the received data storage unit 5 and the past communication conditions of the radio units for communication being stored in the communication characteristic accumulation and storage unit 6, if the presumed communication conditions have deteriorated more than a predetermined threshold from ideal conditions (initial conditions are assumed to be ideal conditions, as will be described later) or immediately previous conditions, physical parameter update processing is performed.

Physical parameter update processing involves decision making as to whether communication conditions presumed by the radio wave environment computation unit 2 through the electromagnetic field computation model become substantially better than the current communication conditions as a result of actually modifying a modifiable physical parameter; if so, processing to modify the physical parameter is performed practically. For some type of physical parameters of electromagnetic waves that are modifiable by the radio units comprised in the communication system, improvement in communication conditions may not be accomplished, no matter how to modify a physical parameter that is modifiable. Therefore, before practically modifying physical parameters of the radio units 22 for communication, simulation is run on the electromagnetic field computation model.

For this reason, the following are performed: changing the values of physical parameters according to predetermined rules on the electromagnetic field computation model to presume communication conditions; and, while monitoring results, seeking for a physical parameter that decreases difference from ideal conditions when modified.

As for a commonly used control method, it is conceivable to update physical parameters so that radio communication quality will improve by an optimization algorithm without attainment targets. However, when the radio system is introduced, parameters are typically adjusted to optimal values in an environment where irregularly moving objects do not exist. Therefore, in the present embodiment, communication conditions (initial conditions) of the radio units for communication measured at the time of introduction are regarded as attainment target values and control is implemented accordingly; complex algorithms are not used.

After writing physical parameters updated as noted above into the physical parameter storage unit 7, the controller transmits the contents of the physical parameter storage unit 7 to each of the radio units 22 for communication (S206). The radio units 22 for communication receive updated physical parameters (S207). Using the received physical parameters, each of the radio units 22 for communication modifies the physical parameters (transmission parameters) of electromagnetic waves that they use for communication (S208). After that, each radio unit transmits communication data to another radio unit 22 for communication and the controller 10 or another radio unit such as a base station which is not depicted (S209). Each radio unit 22 for communication receives communication data from another radio unit for communication (S210). Then, each radio unit computes communication status, e.g., received signal strength (S211). Communication characteristics data thus computed is transmitted to the controller 10 (S212).

The controller 10 receives the communication characteristics data (S213) and accumulates and records that data into the communication characteristic accumulation and storage unit 6 (S214). Then, the controller computes change of communication characteristics data over time (S215) and decides whether or not communication characteristics have deteriorated (S216).

If communication characteristics have not deteriorated, a return is then made to the step S213 and the controller acquires communication characteristics data from the radio units 22 for communication. If communication characteristics have deteriorated, a return is made to the step S201 and the controller reconfigures physical parameters.

According to the present embodiment, it is possible to perform communication, while modifying physical parameters of electromagnetic waves that multiple radio units comprised in the radio system use for communication so as to restrain variation of the radio wave environment caused by movement of physical entities in the radio wave environment within the communication service area. Consequently, this provides an advantageous effect for stabilizing communication performance of the radio system and it is possible to accomplish improvement in communication quality.

In the present embodiment, the respective radio units 22 for communication transmit and receive mutually and each of them transmits communication characteristics data to the controller 10. Therefore, setting physical parameters is performed with respect to each radio unit 22 for communication. Besides, when setting physical parameters for one radio unit for communication, it is required to take account of communication characteristics data of other radio units for communication. Instead of many-to-many transmission/reception, in the case of many-to-one communication where multiple radio units for communication transmit toward a signal base station, the base station is to compute communication characteristics data of each of the radio units for communication and set physical parameters for each of them in a simpler manner.

### Second Embodiment

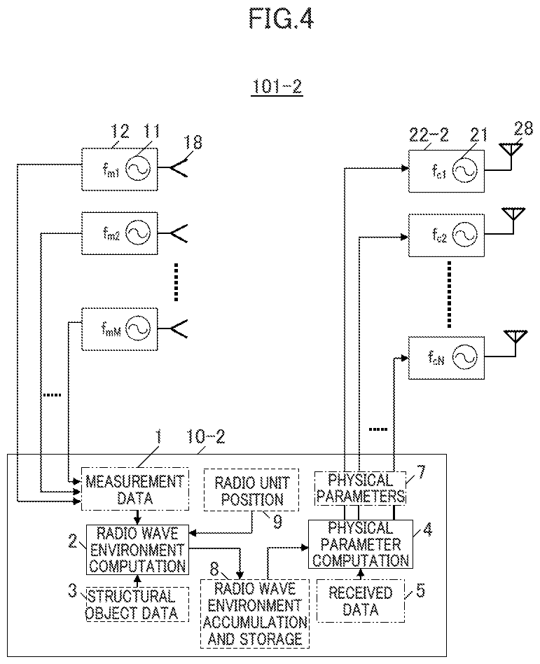

With FIGS. 4, 5A, 5B, and 6, descriptions are provided of another example of a radio system adapted to stabilize communication quality when the radio communication environment changes.

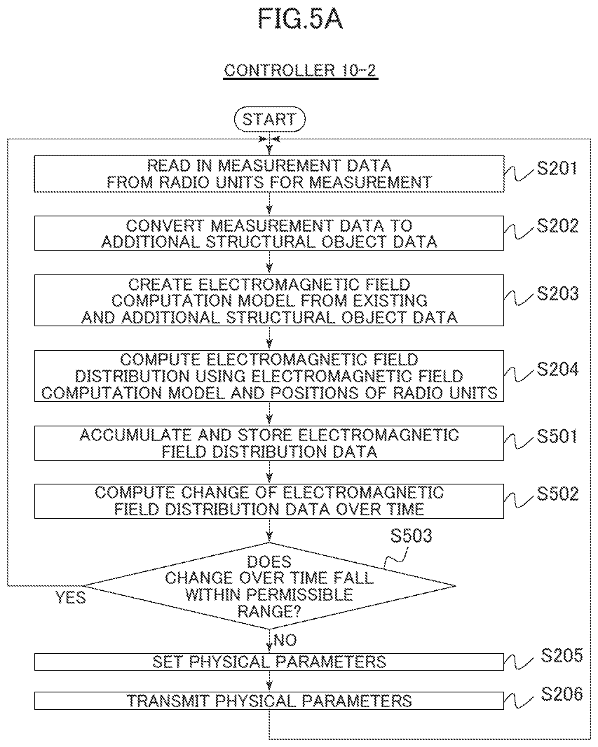

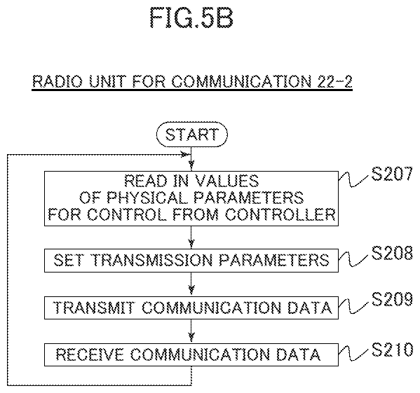

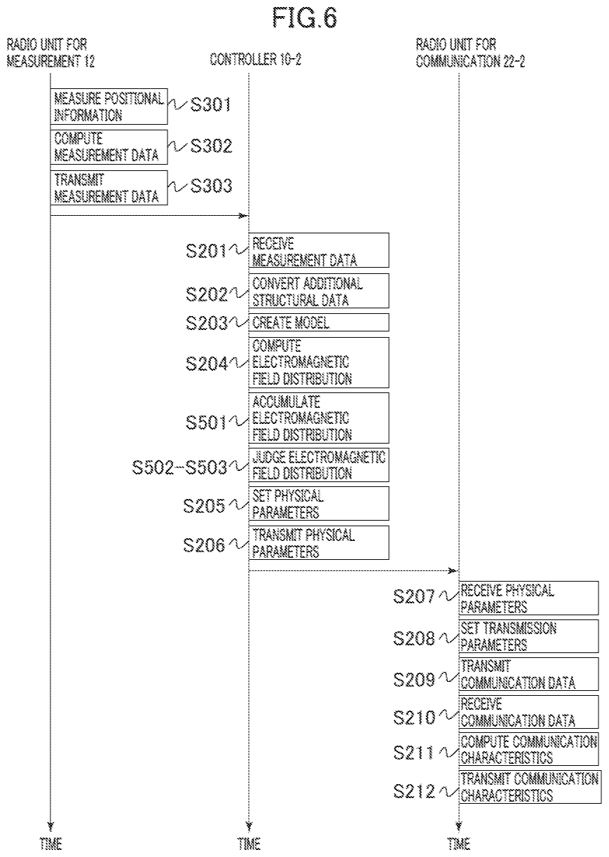

FIG. 4 is a diagram to explain a configuration of the radio system 101-2 adapted to stabilize communication quality when the radio communication environment changes. FIG. 5A is a flowchart to explain operation of a controller 10-2. FIG. 5B is a flowchart to explain operation of a radio unit 22-2 for communication. FIG. 6 is a diagram to explain operation timing.

Because the radio system 101-2 has a configuration that is partially common with the configuration of the radio system 101 of FIG. 1A, a different part from the first embodiment is described. In the second embodiment, processing steps S201 through S204 and steps S501 through S503 in FIG. 5A should be regarded as processing loops that are run routinely. The controller iterates these loop processing steps periodically and monitors communication conditions of the radio units 22 for communication on the cyber space. If the characteristics have been deteriorated, the controller proceeds to modifying physical parameters.

After creating an electromagnetic field computation model (S203), the radio wave environment computation unit 2 computes an electromagnetic field distribution in the service area through the electromagnetic field computation model (S204) and accumulates the electromagnetic field distribution into a radio wave environment accumulation and storage unit 8 (S501).

With the physical parameter computation unit 4, a computation is made of variation of the electromagnetic field distribution accumulated in the radio wave environment accumulation and storage unit 8 (S502). A decision is made as to whether the variation falls within a permissible range (S503). If the electromagnetic field distribution has varied beyond the permissible range, the following are performed: changing the values of physical parameters of electromagnetic waves that the radio units for communication use for communication through the electromagnetic field computation model; and computing a new combination of physical parameters of electromagnetic waves that decreases the variation of the electromagnetic field distribution when modified (S205).

After writing a combination of physical parameters thus computed into the physical parameter storage unit 7, the controller transmits the contents of the physical parameter storage unit 7 to each of the radio units 22 for communication (S206).

The radio units 22 for communication read in the thus transmitted data (S207) and, by using this data, modify the physical parameters of electromagnetic waves that they use for communication (S208).

In the second embodiment, the radio wave environment accumulation and storage unit 8 is provided to accumulate and store historical data on the radio wave environment computed through the electromagnetic field computation model instead of the communication characteristic accumulation and storage unit 6, which is removed in the second embodiment, to accumulate and store communication characteristics in the first embodiment. A decision is made as to whether it is necessary to update physical parameters based on variation of the radio wave environment.

In the first embodiment, the controller monitors communication characteristics data computed on the radio units 22 for communication to decide whether it is necessary to modify physical parameters (S211, S212 in FIG. 2B). Instead, in the second embodiment, the controller monitors variation of the radio wave environment obtained through the electromagnetic field computation model from measurement data from the radio units 12 for measurement to decide whether it is necessary to modify physical parameters (S501 to S503 in FIG. 5A).

In order to implement fine granularity control in time domain, while observing the radio environment, it is required to shorten the time interval to acquire communication characteristics data from the radio units 22 for communication in the first embodiment or shorten the time interval to compute data on the radio wave environment through the electromagnetic field computation model in the second embodiment. In comparison with the first embodiment, in the second embodiment, burdens on the radio units 22-2 for communication decreases as in FIGS. 5B and 6, whereas there is an increase in the frequency of computer processing on the controller 10-2 to process data regarding mobile objects which is taken in from the radio units 12 for measurement. Especially, there is a large load to create an electromagnetic field computation model. A decision as to which embodiment is adopted should be made according to application and hardware configuration.

According to the present embodiment, it is possible to perform communication, while modifying physical parameters of electromagnetic waves that multiple radio units comprised in the radio system use for communication so as to restrain variation of the radio wave environment caused by movement of physical entities in the radio wave environment within the communication service area. Consequently, this provides an advantageous effect for stabilizing communication performance of the radio system and it is possible to accomplish improvement in communication quality.

In the foregoing first and second embodiments, a decision is made as to whether or not it is required to modify physical parameters, based on variation of communication characteristics data or variation of the radio wave environment obtained through a certain model. In a method, such a decision may be made through comparison between communication characteristics data and the radio wave environment communication obtained through a certain model, provided that the model has high accuracy.

### Third Embodiment

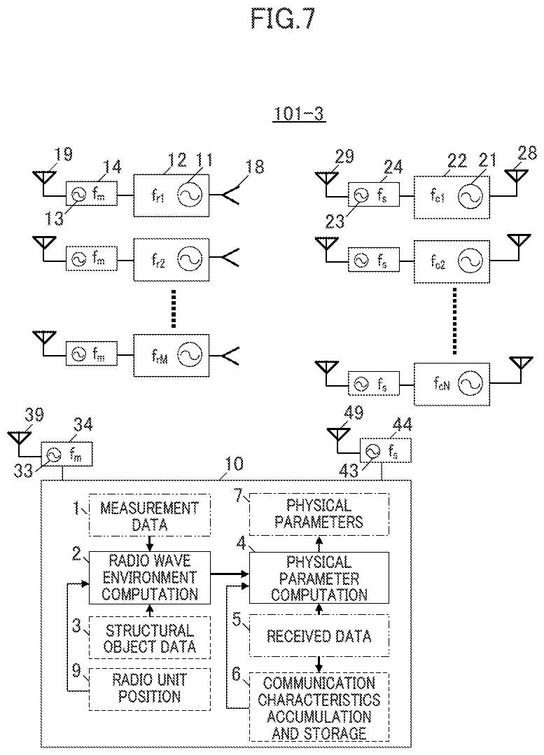

With FIG. 7, descriptions are provided of another example of a radio system according to another embodiment. FIG. 7 is a diagram to explain a configuration of the radio system 101-3 adapted to stabilize communication quality when the radio communication environment changes.

The radio system of a third embodiment has basically the same configuration as in the first embodiment of FIG. 1A. A different part from the first embodiment is described. In the third embodiment, each of radio units 12 for measurement is equipped with an auxiliary radio unit 14 for measurement to communicate with the controller 10. The auxiliary radio unit 14 for measurement is equipped with its carrier frequency generator 13 and its antenna 19.

Also, each of radio units 22 for communication is equipped with an auxiliary radio unit 24 for communication to communicate with the controller 10. The auxiliary radio unit 24 for communication is equipped with its carrier frequency generator 23 and its antenna 29.

The controller 10 is equipped with a first auxiliary radio unit 34 for controller to communicate with each auxiliary radio unit 14 for measurement. The first auxiliary radio unit 34 for controller is equipped with its carrier frequency generator 33 and its antenna 39. The controller 10 is further equipped with a second auxiliary radio unit 44 for controller to communicate with each auxiliary radio unit 24 for communication. The second auxiliary radio unit 44 for controller is equipped with its carrier frequency generator 43 and its antenna 49.

As the radio system is configured as above in the third embodiment, measurement data is transferred between each radio unit 12 for measurement and the controller 10 through transmission between the antenna 19 of each auxiliary radio unit for measurement and the antenna 39 of the first auxiliary radio unit for controller. Also, data to receive and physical parameters are transferred by radio between each radio unit 22 for communication and the controller 1 through transmission between the antenna 29 of each auxiliary radio unit for communication and the antenna 49 of the second auxiliary radio unit for controller.

In comparison with the first embodiment, the radio system configuration according to the present embodiment dispenses with cabling for data transfer between each of the radio units 12 for measurement and the controller 1 and between each of the radio units 22 for measurement and the controller 1; this increases the degree of freedom of placement of the radio units 12 for measurement and the radio units 22 for communication and provides an advantageous effect for reducing the hardware cost of the radio system as a whole.

### Fourth Embodiment

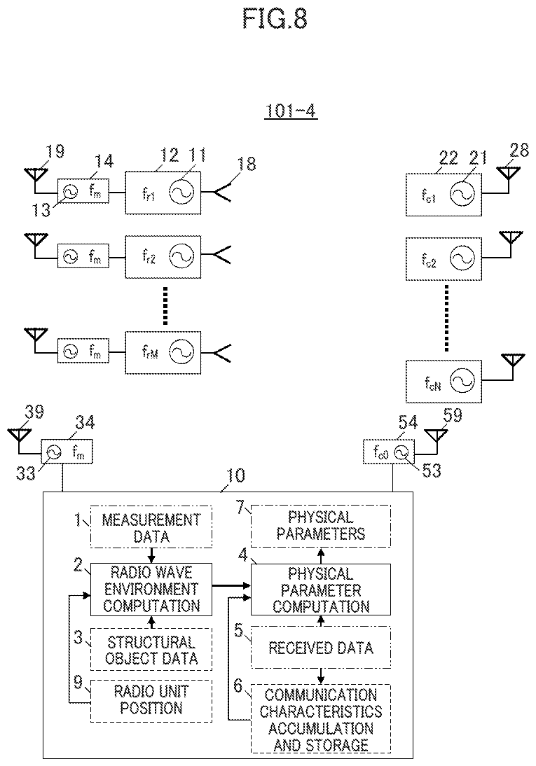

With FIG. 8, descriptions are provided of another example of a radio system according to another embodiment. FIG. 8 is a diagram to explain a configuration of the radio system 101-4 adapted to stabilize communication quality when the radio communication environment changes.

The radio system of a fourth embodiment has basically the same configuration as in the first embodiment of FIG. 1A. A different part from the first embodiment is described. In the fourth embodiment, each of radio units 12 for measurement is equipped with an auxiliary radio unit 14 for measurement to communicate with the controller 10. The auxiliary radio unit 14 for measurement is equipped with its carrier frequency generator 13 and its antenna 19.

Besides, the controller 10 is equipped with a first auxiliary radio unit 34 for controller to communicate with each auxiliary radio unit 14 for measurement. The first auxiliary radio unit 34 for the controller is equipped with its carrier frequency generator 33 and its antenna 39.

The controller 10 is further equipped with a third auxiliary radio unit 54 for controller to communicate with each radio unit 22 for communication. The third auxiliary radio unit 54 for controller is equipped with its carrier frequency generator 53 and its antenna 59.

As the radio system is configured as above, measurement data can be transferred by radio between each radio unit 12 for measurement and the controller 10 through transmission between the antenna 19 of each auxiliary radio unit for measurement and the antenna 39 of the first auxiliary radio unit for controller. Also, communication characteristics data and physical parameters can be transferred by radio between each radio unit 22 for communication and the controller 10 through transmission between the radio unit's antenna 28 for communication and the antenna 59 of the third auxiliary radio unit for controller using a period of time when no communication is performed between radio units 22 for communication.

In comparison with the embodiment of FIG. 7, the radio system configuration according to the present embodiment dispenses with the auxiliary radio units 24 for communication which are added to the radio units 22 for communication; this can reduce the cost for manufacturing the radio units 22 for communication. Consequently, this provides an advantageous effect for reducing the hardware cost of the radio system as a whole.

### Fifth Embodiment

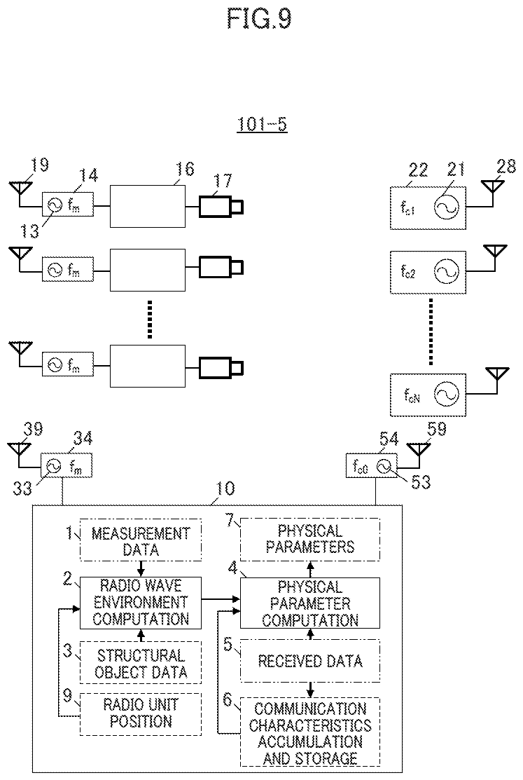

With FIG. 9, descriptions are provided of another example of a radio system according to another embodiment. FIG. 9 is a diagram to explain a configuration of the radio system 101-5 adapted to stabilize communication quality when the radio communication environment changes.

The radio system of a fifth embodiment has basically the same configuration as in the fourth embodiment of FIG. 8. Difference from the forth embodiment resides in that each radio unit 12 for measurement is replaced with a camera instrument 17 for measurement and an image processing unit 16. The image processing unit 16 computes distance to an object from camera images and creates measurement data. According to the present embodiment, accuracy of measurements on the positions and shapes of objects in the service area can be improved, as compared with the embodiment of FIG. 8. Consequently, this embodiment enables precise computation of physical parameters that are modified to stabilize communication characteristics in the service area and provides an advantageous effect for improving stability of communication conditions in the system.

### Sixth Embodiment

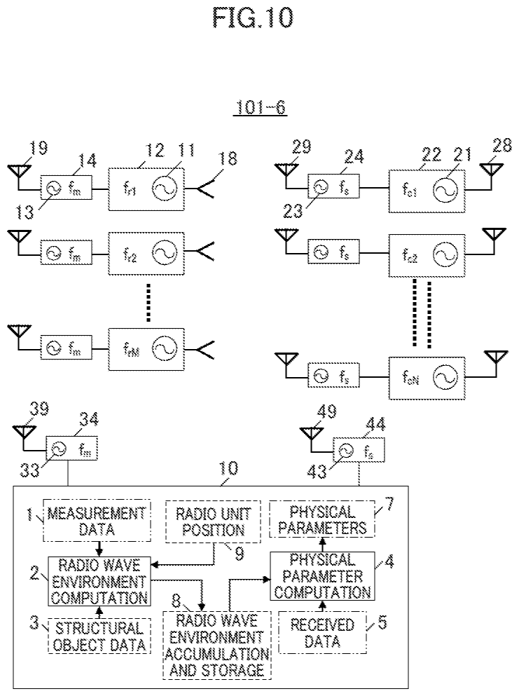

With FIG. 10, descriptions are provided of another example of a radio system according to another embodiment. FIG. 10 is a diagram to explain a configuration of the radio system 101-6 adapted to stabilize communication quality when the radio communication environment changes.

The radio system of a sixth embodiment has basically the same configuration as in the second embodiment of FIG. 4. A different part from the second embodiment is described. Each of radio units 12 for measurement is equipped with an auxiliary radio unit 14 for measurement to communicate with the controller 10. The auxiliary radio unit 14 for measurement is equipped with its carrier frequency generator 13 and its antenna 19. Also, each of radio units 22 for communication is equipped with an auxiliary radio unit 24 for communication to communicate with the controller 10. The auxiliary radio unit 24 for communication is equipped with its carrier frequency generator 23 and its antenna 29.

The controller 10 is equipped with a first auxiliary radio unit 34 for controller to communicate with each auxiliary radio unit 14 for measurement. The first auxiliary radio unit 34 for controller is equipped with its carrier frequency generator 33 and its antenna 39. The controller 10 is further equipped with a second auxiliary radio unit 44 for controller to communicate with each auxiliary radio unit 24 for communication. The second auxiliary radio unit 44 for controller is equipped with its carrier frequency generator 43 and its antenna 49.

As the radio system is configured as above, measurement data can be transferred by radio between each radio unit 12 for measurement and the controller 10 and data to receive and physical parameters can also be transferred by radio between each radio unit 22 for communication and the controller 10.

In contrast with the second embodiment of FIG. 4, the radio system configuration according to the present embodiment dispenses with cabling for data transfer; this increases the degree of freedom of placement of the radio units 12 for measurement and the radio units 22 for communication and provides an advantageous effect for reducing the hardware cost of the radio system as a whole.

### Seventh Embodiment

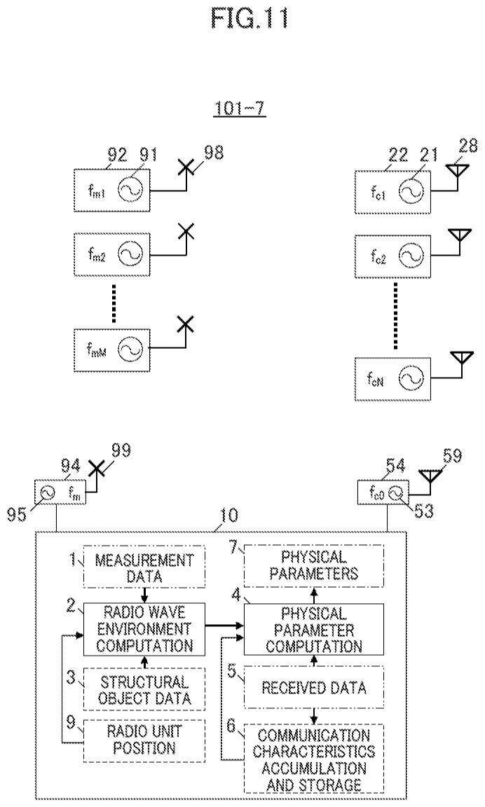

With FIG. 11, descriptions are provided of another example of a radio system according to another embodiment. FIG. 11 is a diagram to explain a configuration of the radio system 101-7 adapted to stabilize communication quality when the radio communication environment changes.

Difference from the fourth embodiment of FIG. 8 resides in that the radio units 12 for measurement are replaced with radio units 92 for measurement using rotating polarization. Each of the radio units 92 for measurement using rotating polarization is equipped with a rotating polarization frequency generator 91 for measurement and a rotating polarization antenna 98 for measurement. The radio units 92 for measurement using rotating polarization transmit radio waves with the rotating plane of polarization at a frequency fₘᵢ generated by the rotating polarization frequency generator 91 for measurement. The radio units 92 for measurement using rotating polarization are capable of measuring the position and shape of an object by radar principles like the radio units for measurement in the foregoing embodiments and also capable of detecting change in the position and shape of an object by measuring change of the plane of polarization of radio waves they receive. This is because the plane of polarization of radio waves changes with change in the position and shape of an object existing on the path of radio wave propagation.

The radio units 92 for measurement using rotating polarization perform taking measurements of an object and transmitting measurement data to the controller in a time division manner. To transmit measurement data to the controller 10, expediently, radio waves used for measurement should be used as carrier waves and modulated with measurement data.

In the case of communication using rotating polarization, as placement of electromagnetic wave scatterers surrounding a transmitter/receiver changes, the polarization shift between transmitting and receiving waves changes. Therefore, the radio units 92 for measurement using rotating polarization measure that shift. In contrast with radar operation in which the location of a mobile object is measured directly, measurement using rotating polarization in the present embodiment requires that radio units communicate with each other via rotating polarization waves and mutually measure the polarization shift. To measure the polarization shift, for example, polarization phase synchronization is attained between the respective radio units 92 for measurement using rotating polarization.

In the present embodiment, the radio wave environment computation unit 2, for example, creates a model of polarization shift that occurs on a communication path between radio units 92 for measurement using rotating polarization and, through the model, presumes polarization shift that occurs on a communication path between radio units 22 for communication. From each radio unit 22 for communication, the polarization shift of radio waves it received from another radio unit is transmitted to the controller 10 as communication characteristics data.

The controller 10 is equipped with an auxiliary radio unit using rotating polarization 94 for controller to communicate with each radio unit 92 for measurement using rotating polarization. The auxiliary radio unit using rotating polarization 94 for controller is equipped with its rotating polarization frequency generator 91 and its rotating polarization antenna 99. An example of a technical approach regarding rotating polarization communication is found in Japanese Unexamined Patent Application Publication No. 2017-046117.

As the radio system is configured as above, measurement data can be transferred by radio between each radio unit 92 for measurement using rotating polarization and the controller 10 using a period of time when communication regarding measurement is not performed between radio units 92 for measurement using rotating polarization. Also, data to receive and physical parameters can be transferred by radio between each radio unit 22 for communication and the controller 10 using a period of time when no communication is performed between radio units for communication.

In comparison with the third embodiment of FIG. 7, the radio system configuration according to the present embodiment dispenses with the auxiliary radio units which are added to the radio units 12 for measurement and the auxiliary radio units which are added to the radio units 22 for communication; this can reduce the cost for manufacturing the radio units for communication and, consequently, provides an advantageous effect for reducing the hardware cost of the radio system as a whole.

### Eighth Embodiment

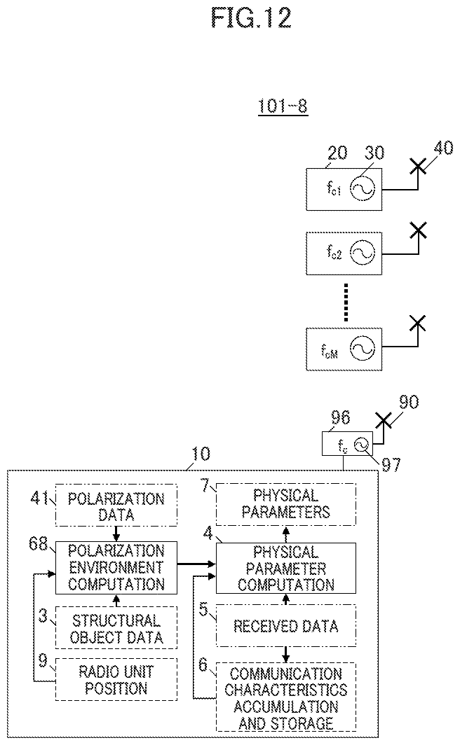

With FIG. 12, descriptions are provided of another example of a radio system adapted to stabilize communication quality when the radio communication environment changes. FIG. 12 is a diagram to explain a configuration of the radio system 101-8 adapted to stabilize communication quality when the radio communication environment changes.

The radio system 101-8 is comprised of multiple radio units 20 for communication using rotating polarization and a controller 10 that transfers and receives data to/from each of the radio units 20 for communication using rotating polarization. Each radio units 20 for communication using rotating polarization is equipped with a rotating polarization frequency generator 30 for communication and a rotating polarization antenna 40 for communication.

The controller 10 is equipped with a polarization data storage unit 41 and reads in and stores data on polarization waves that the radio units 20 for communication using rotating polarization use for transmission/reception into this unit. The controller is also equipped with a received data storage unit 5 and reads in and stores data on communication conditions of the radio units 20 for communication using rotating polarization into this unit. Additionally, the controller accumulates the same data contents into the communication characteristic accumulation and storage unit 6.

The controller 10 also stores information of the positions of the radio units 22 for communication using rotating polarization in the service area into the radio unit position storage unit 9 and stores information of the position, shape, and material of a structural object in the service area into the structural object data storage unit 3.

By using the contents of the polarization data storage unit 41, the radio unit position storage unit 9, and the structural object data storage unit 3, a polarization environment computation unit 68 in the controller 10 creates a polarization environment computation model for computing a polarization distribution in the service area. After that, through the polarization environment computation model, the polarization environment computation unit presumes communication conditions of each of the radio units 22 for communication using rotating polarization.

A physical parameter computation unit 4 in the controller 10 compares the presumed communication conditions against the latest communication conditions of the radio units for communication using rotating polarization being stored in the received data storage unit 5 and previous communication conditions of the radio units for communication being stored in the communication characteristic accumulation and storage unit 6 and decides whether or not it is necessary to update physical parameters of electromagnetic waves that each radio unit 20 for communication using rotating polarization uses for communication.

If it is necessary to update physical parameters, the physical parameters are updated and written into the physical parameter storage unit 7. The controller transmits the contents of the physical parameter storage unit 7 to each of the radio units 20 for communication using rotating polarization. Using the thus transmitted data, the radio units 20 for communication using rotating polarization modify the physical parameters of electromagnetic waves that they use for communication.

As noted in the section of the seventh embodiment 7, polarization distribution also changes depending on the position and shape of an object. Because only mobile objects 1013 subject to change in position and shape in the service area, initial conditions where no mobile objects 1013 exist in the area are assumed to be an ideal radio wave environment. Under this assumption, physical parameters (e.g., the plane of polarization of transmission waves) should be controlled so that approximation is made to a radio environment distribution (e.g., polarization distribution) in the initial conditions.

According to the present embodiment, the individual radio units 12 for measurement are removed and it is possible to perform communication, while modifying physical parameters of electromagnetic waves that multiple radio units comprised in the radio system use for communication so as to restrain variation of the radio wave environment caused by movement of physical entities in the radio wave environment within the communication service area. Consequently, this provides an advantageous effect for stabilizing communication performance of the radio system and it is possible to accomplish improvement in communication quality.

### Ninth Embodiment

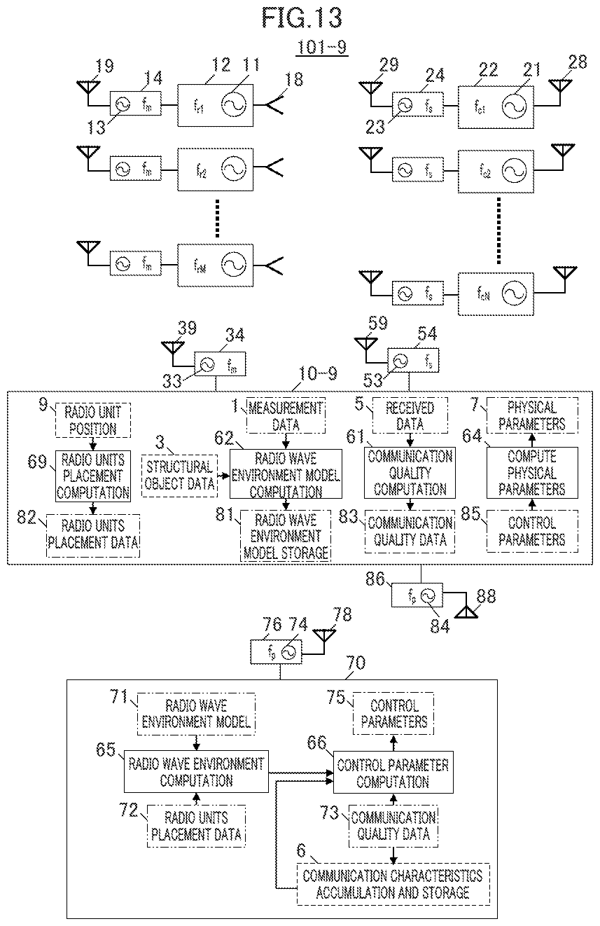

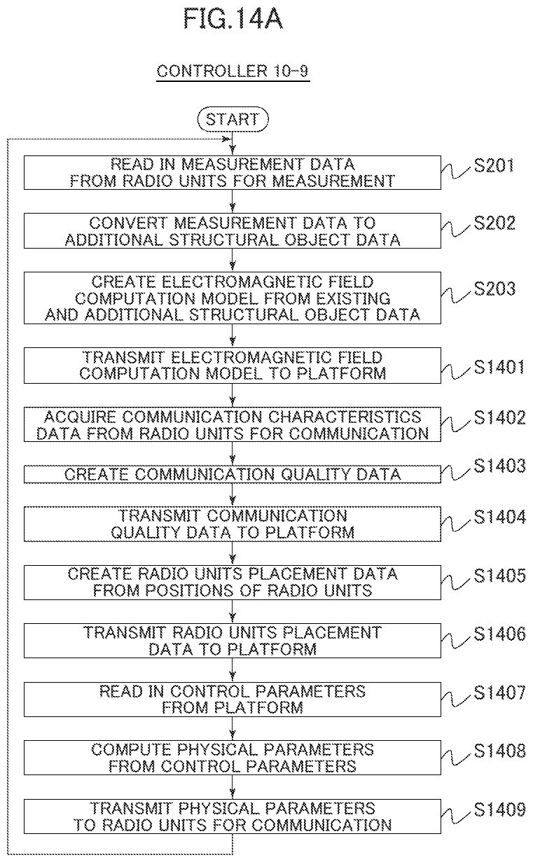

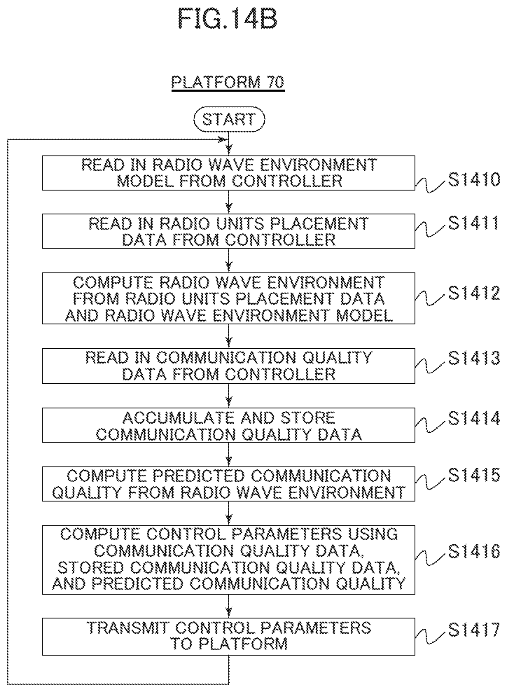

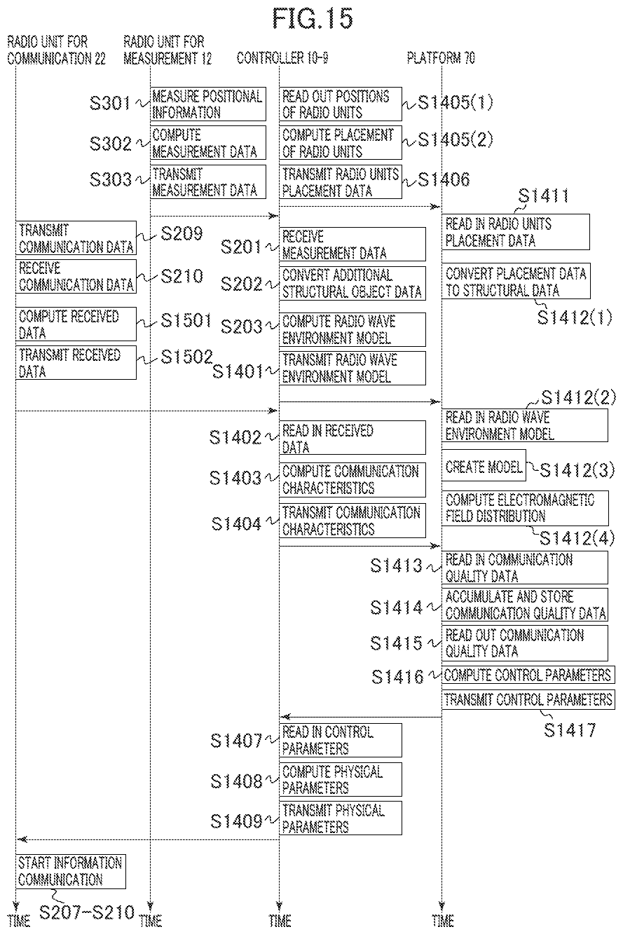

With FIGS. 13, 14A, 14B, and 15, descriptions are provided of an example of a radio system according to another embodiment. FIG. 13 is a diagram to explain another configuration of a radio system adapted to stabilize communication quality when the radio communication environment changes. FIGS. 14A and 14B are flowcharts to explain operation and FIG. 15 is a diagram to explain operation timing.

The radio system 101-9 is comprised of multiple radio units 12 for measurement, multiple radio units 22 for communication, a controller 10-9 that transfers and receives data to/from each of the radio units 12 for measurement and the radio units 22 for communication, and a server for platform 70 that transfers and receives data to/from the controller 10-9.

Each radio unit 12 for measurement is equipped with its carrier frequency generator 11 and an antenna 18 for measurement and combined with an auxiliary radio unit 14 for measurement. The auxiliary radio unit 14 for measurement is equipped with its carrier frequency generator 13 and its antenna 19. The radio units 12 for measurement transfer measurement data to the controller 10-9.

Each radio unit 22 for communication is equipped with its carrier frequency generator 21 and an antenna 28 for communication and combined with an auxiliary radio unit 24 for communication. The auxiliary radio unit 24 for communication is equipped with its carrier frequency generator 23 and its antenna 29. The radio units 22 for communication transfer and receive data to/from the controller 10-9.

The controller 10-9 is equipped with a first auxiliary radio unit 34 for controller to receive measurement data from the radio units 12 for measurement; the first auxiliary radio unit 34 for controller is equipped with its carrier frequency generator 13 and its antenna 19.

The controller 10-9 is also equipped with a second auxiliary radio unit 54 for controller to transfer and receive data to/from the radio units 22 for communication; the second auxiliary radio unit 54 for controller is equipped with its carrier frequency generator 53 and its antenna 59.

The controller 10-9 is also equipped with a fourth auxiliary radio unit 86 for controller to transfer and receive data to/from the server for platform 70; the fourth auxiliary radio unit 86 for controller is equipped with its carrier frequency generator 84 and its antenna 88.

Besides, the server for platform 70 is equipped with an auxiliary radio unit 76 for server to transfer and receive data to/from the controller 10-9; the auxiliary radio unit 76 for server is equipped with its carrier frequency generator 74 and its antenna 78.

The controller 10 is equipped with the measurement data storage unit 1 and reads in and stores measurement data from the radio units 12 for measurement into this unit (S201). The controller also stores information of the position, shape, and material of a structural object in the service area into the structural object data storage unit 3. Besides, by using the contents of the measurement data storage unit 1 and the structural object data storage unit 3, a radio wave environment model computation unit 62 creates a radio wave environment model for computing a radio wave environment in the service area (S203). The radio wave environment model is stored into a radio wave environment model accumulation and storage unit 81 and transmitted to the server for platform 70 (S1401).

The controller 10-9 is also equipped with the received data storage unit 5 and reads in and stores data on communication conditions of the radio units 22 for communication into this unit (S1402). By using the data on communication conditions, a communication quality computation unit 61 computes communication quality data (S1403). The thus obtained data on communication quality is stored into a communication quality data transmit buffer 83 and transmitted to the server for platform 70 (S1404).

The controller 10-9 stores information of the positions of the radio units 22 for communication in the service area into the radio unit position storage unit 9. By using the positional information thus stored, a radio unit placement computation unit 69 creates radio unit placement data (S1405) which is in turn transmitted to the server for platform 70 (S1406). The thus obtained data is stored into a radio unit placement data transmit buffer 82.

The server for platform 70 reads the radio wave environment model into a radio wave environment model receive buffer 71 (S1410). The server for platform 70 also reads the radio unit placement data into a radio unit placement data receive buffer (S1411). By using the contents of the radio wave environment model receive buffer 71 and the radio unit placement data receive buffer 72, a radio wave environment computation unit 65 creates an electromagnetic field computation model for computing an electromagnetic field distribution in the service area (S1412).

After that, the radio wave environment computation unit 65 presumes communication quality of each of the radio units 22 for communication by using the electromagnetic field computation model and, then, reads the communication quality data into a communication quality data receive buffer 73 and accumulates the data contents into the communication characteristic accumulation and storage unit 6 (S1414). A control parameter computation unit 66 compares the presumed communication quality against the latest communication quality of the radio units for communication being stored in the communication quality data receive buffer 73 and previous communication quality of the radio units for communication being stored in the communication characteristic accumulation and storage unit 6 and decides whether or not it is necessary to update physical parameters of electromagnetic waves that each radio unit 22 for communication uses for communication. If it is necessary to update physical parameters, the control parameter computation unit 66 writes control parameters relevant to the physical parameters to be updated into a control parameter transmit buffer 57 (S2316-2320).

Furthermore, the controller 10-9 reads the control parameters into a control parameter receive buffer 85 (S1407). By using the contents of the control parameter receive buffer 85, a physical parameter computation unit 64 determines the physical parameters of electromagnetic waves that the radio units 22 for communication should use (S1408).

After storing the thus determined physical parameters into the physical parameter storage unit 7, the controller transmits the contents of the physical parameter storage unit 7 to each of the radio units 22 for communication (S1409). Using the thus transmitted data, the radio units 22 for communication modify the physical parameters of electromagnetic waves that they use for communication. Then, information communication begins (S207-S210).

According to the present embodiment, it is possible to perform communication, while modifying physical parameters of electromagnetic waves that multiple radio units comprised in the radio system use for communication so as to restrain variation of the radio wave environment caused by movement of physical entities in the radio wave environment within the communication service area. Consequently, this provides an advantageous effect for stabilizing communication performance of the radio system and it is possible to accomplish improvement in communication quality. Moreover, processing that requires a huge amount of computation in sequential operations can be carried out by the platform in a server that is easily accessible through a network; this provides an advantageous effect for reducing hardware introduction cost to a large extent.

### Tenth Embodiment

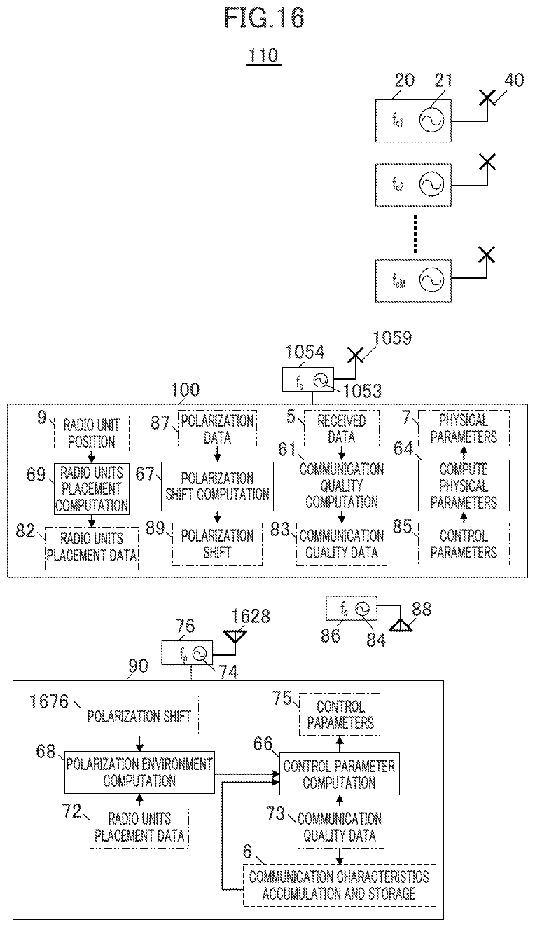

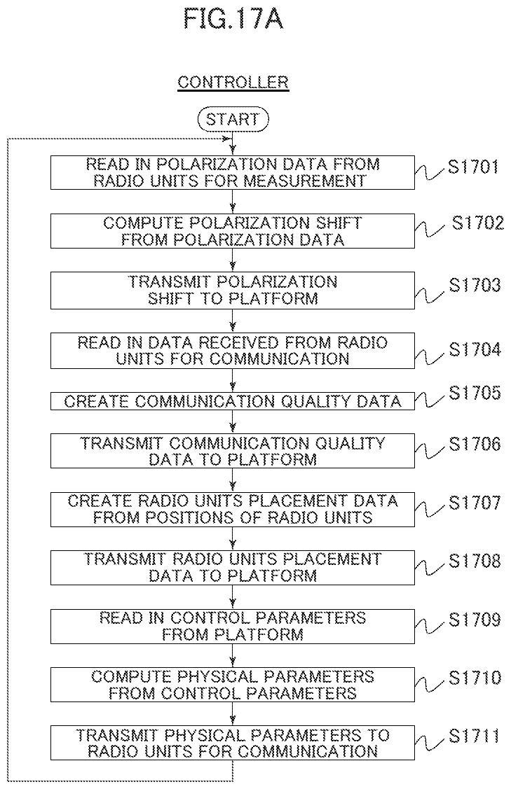

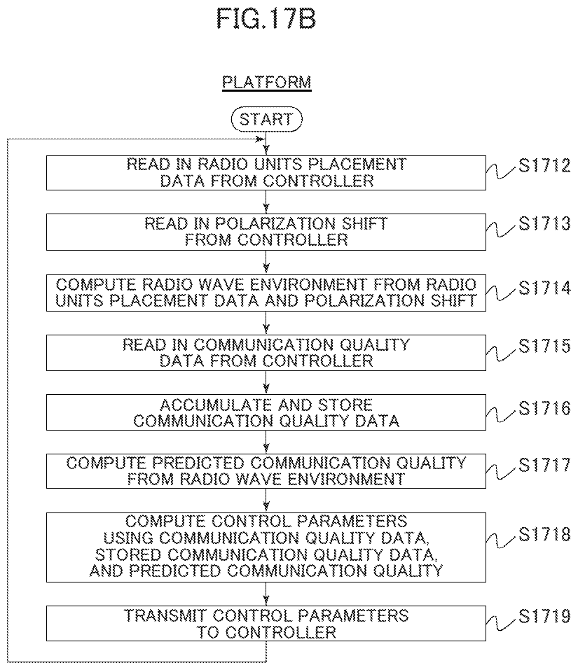

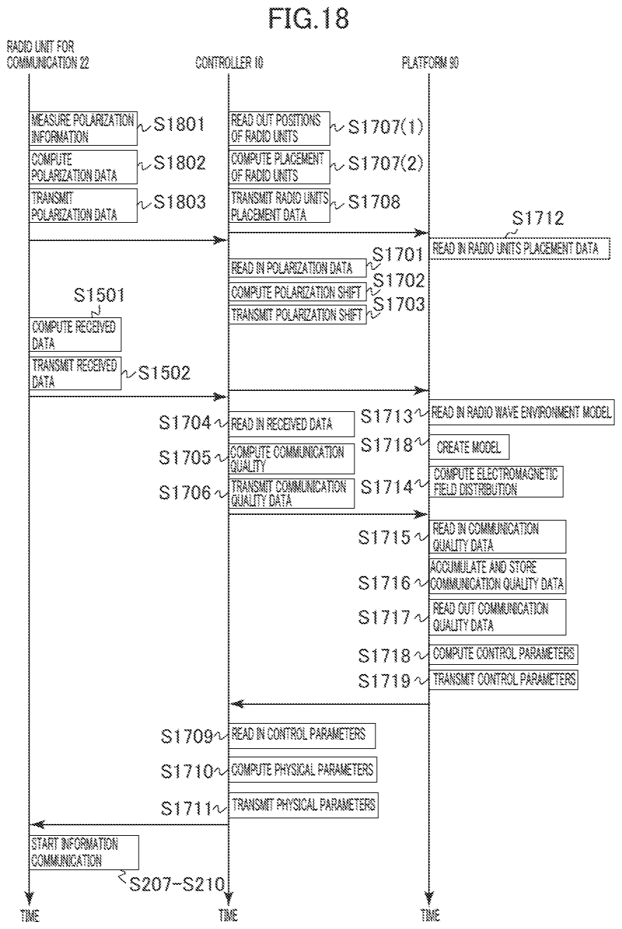

With FIGS. 16, 17A, 17B, and 18, descriptions are provided of an example of a radio system adapted to stabilize communication quality when the radio communication environment changes according to the present invention. FIG. 16 is a diagram to explain another configuration of a radio system. FIGS. 17A and 17B are flowcharts to explain operation and FIG. 18 is a diagram to explain operation timing.

The radio system 110 is comprised of multiple radio units 20 for communication using rotating polarization, a controller 100 that transfers and receives data to/from each of the radio units 20 for communication using rotating polarization, and a server for platform 90 that transfers and receives data to/from the controller 100.

Each radio unit 20 for communication using rotating polarization is equipped with a rotating polarization frequency generator 21 for measurement and a rotating polarization antenna 40 for measurement. Communication takes place between radio units for communication using rotating polarization and also between a radio unit for communication using rotating polarization and the controller.

The controller 100 is equipped with an auxiliary radio unit 1054 using rotating polarization for controller; the auxiliary radio unit 1054 using rotating polarization for controller is equipped with its rotating polarization frequency generator 1053 and its antenna 1059. The controller 100 transfers and receives data to/from the radio units 20 for communication using rotating polarization. The controller 100 is also equipped with a fourth auxiliary radio unit 86 for controller to transfer and receive data to/from the server for platform 90; the fourth auxiliary radio unit 86 for controller is equipped with its carrier frequency generator 94 and its antenna 88.

The server for platform 90 is equipped with an auxiliary radio unit 76 for server to transfer and receive data to/from the controller 100; the auxiliary radio unit 76 for server is equipped with its carrier frequency generator 74 and its antenna 1628.

The controller 100 is equipped with a polarization data receive buffer 87 and reads in and stores data on polarization waves that the radio units 20 for communication using rotating polarization use for transmission/reception into this buffer (S1701). By using the contents of the polarization data receive buffer 87, a polarization shift computation unit 67 creates a polarization shift that is required to compute a polarization environment in the service area and stores the polarization shift into a polarization shift transmit buffer 89 (S1702). The polarization shift is transmitted to the server for platform 90 (S1703).

The controller 100 is equipped with the received data storage unit 5 and reads in and stores data on communication conditions of the radio units 20 for communication using rotating polarization into this unit (S1704). By using that data, the communication quality computation unit 61 in the controller 100 computes communication quality data (S1705). The thus obtained data on communication quality is stored into a communication quality data transmit buffer 83 and transmitted to the server for platform 90 (S1706).

The controller 100 stores information of the positions of the radio units 20 for communication using rotating polarization in the service area into the radio unit position storage unit 9. By using that positional information, a radio unit placement computation unit 69 creates radio unit placement data (S1707). The thus obtained data is stored into a radio unit placement data transmit buffer 82 and transmitted to the server for platform 90 (S1708).

The server for platform 90 reads the polarization shift into a polarization shift receive buffer 1676 (S1713) and reads the radio unit placement data into a radio unit placement data receive buffer 72 (S1712).

By using the contents of the polarization shift receive buffer 1676 and the radio unit placement data receive buffer 72, a polarization environment computation unit 68 in the server for platform 90 creates a polarization environment computation model for computing a polarization distribution in the service area (S1714). After that, by using the polarization environment computation model, the polarization environment computation unit 68 presumes communication quality of each of the radio units 20 for communication using rotating polarization (S1717) and, then, reads the communication quality data into a communication quality data receive buffer 73 (S1716). At the same time, this unit accumulates the communication quality data into the communication characteristic accumulation and storage unit 6 (S1715).

A control parameter computation unit 66 compares the presumed communication quality against the latest communication quality of the radio units for communication being stored in the communication quality data receive buffer 73 and previous communication quality of the radio units for communication being stored in the communication characteristic accumulation and storage unit 6. The control parameter computation unit 66 then decides whether or not it is necessary to update physical parameters of electromagnetic waves that each radio unit 20 for communication using rotating polarization uses for communication. If it is necessary to update physical parameters, the control parameter computation unit 66 writes control parameters relevant to the physical parameters to be updated into a control parameter transmit buffer 75 (S1718). The control parameters are transmitted to the controller 100 (S1719).

Furthermore, the controller 100 reads the control parameters into a control parameter receive buffer 85 (S1709). By using the contents of the control parameter receive buffer 85, a physical parameter computation unit 64 determines the physical parameters of electromagnetic waves that the radio units 20 for communication using rotating polarization should use (S1710). After the physical parameters are stored into the physical storage unit 7, the contents of the physical storage unit 7 are transmitted to each of the radio units 20 for communication using rotating polarization (S1711). Using the thus transmitted data, the radio units 20 for communication using rotating polarization modify the physical parameters of electromagnetic waves that they use for communication.

According to the present embodiment, it is possible to perform communication, while modifying the rotating polarization frequency and transmission/reception timing that are physical parameters of electromagnetic waves that multiple radio units using rotating polarization comprised in the radio system use for communication so as to restrain variation of the radio wave environment caused by movement of physical entities in the radio wave environment within the communication service area.

Consequently, this provides an advantageous effect for stabilizing communication performance of the radio system and it is possible to accomplish improvement in communication quality. Moreover, processing that requires a huge amount of computation in sequential operations can be carried out by the platform in a server that is easily accessible through a network and it is not required to introduce new radio units for measurement to measure the position, shape, and properties of an object in the service area. This provides an advantageous effect for reducing hardware introduction cost for the user of the radio system of the present invention to a large extent.

### Eleventh Embodiment

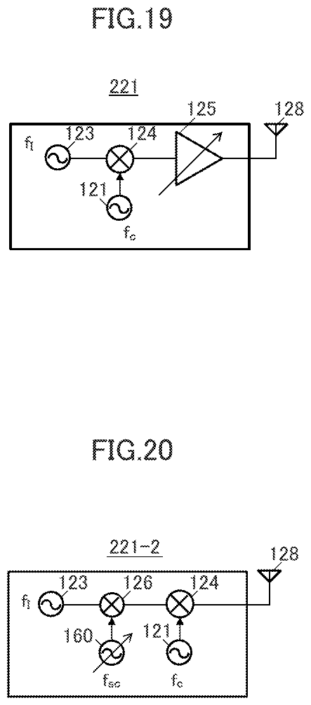

An eleventh embodiment is described with FIG. 19. In the present embodiment, descriptions are provided of operation of transmitter circuitry of a radio unit for communication to modify physical parameters of electromagnetic waves that are used for communication. FIG. 19 is an example of a configuration diagram of a transmitter for use in the radio system.

The transmitter 221 is equipped with an information signal generating circuit 123, a carrier frequency generating circuit 121, a first transmission mixer 124, a variable gain power amplifier 125, and a first antenna 128. An information signal generated by the information signal generating circuit 123 is mixed with a carrier generated by the carrier frequency generating circuit 121 and up-converted by the first transmission mixer 124. After the signal power is amplified by the variable gain power amplifier 125, the signal is radiated into space via the first antenna 128.

The present transmitter is capable of varying amplitude or transmission power that is a physical parameter of electromagnetic waves according to physical parameter information that is given from the controller. By thus varying the output power distribution among multiple radio units for communication comprised in the radio system, it is enabled to restrain variation of the radio wave environment caused by movement of physical entities in the radio wave environment within the communication service area. This provides an advantageous effect for stabilizing communication performance of the radio system.

### Twelfth Embodiment

A twelfth embodiment is described with FIG. 20. In the present embodiment, descriptions are provided of operation of transmitter circuitry of a radio unit for communication to modify physical parameters of electromagnetic waves that are used for communication. FIG. 20 is another example of a configuration diagram of a transmitter for use in the radio system.

The transmitter 221-2 is equipped with an information signal generating circuit 123, a carrier frequency generating circuit 121, a first transmission mixer 124, a variable rotating polarization frequency generating circuit 160, a third transmission mixer 126, and a first antenna 128.

An information signal generated by the information signal generating circuit 123 is mixed with a subcarrier generated by the variable rotating polarization frequency generating circuit 160 and modulated by the third transmission mixer 126 for subcarrier. Then, the signal is mixed with a carrier generated by the carrier frequency generating circuit 121 and up-converted by the first transmission mixer 124 and radiated into space via the first antenna 128.

The present transmitter is capable of varying frequency that is a physical parameter of electromagnetic waves according to physical parameter information that is given from the controller. Dimensions of objects that may exist in a radio communication service area are generally on the order of meters; therefore, the transmitter should use a subcarrier frequency f_{sc} with a wavelength on the order equivalent to this order of dimensions. By varying the subcarrier frequency and by thus varying the subcarrier frequency distribution among multiple radio units for communication comprised in the radio system, it is enabled to restrain variation of the radio wave environment caused by movement of physical entities in the radio wave environment within the communication service area. This provides an advantageous effect for stabilizing communication performance of the radio system.

### Thirteenth Embodiment

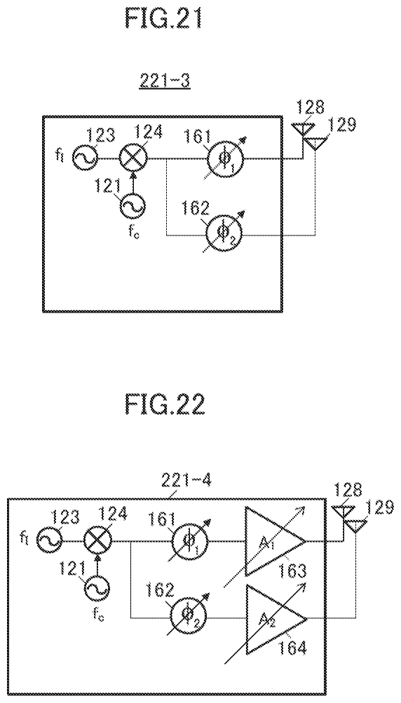

A thirteenth embodiment is described with FIG. 21. In the present embodiment, descriptions are provided of operation of transmitter circuitry of a radio unit for communication to modify physical parameters of electromagnetic waves that are used for communication.

FIG. 21 is another example of a configuration diagram of a transmitter for use in the radio system. The transmitter 221-3 is equipped with an information signal generating circuit 123, a carrier frequency generating circuit 121, a first transmission mixer 124, a first variable phase shifter 161, a second variable phase shifter 162, a first antenna 128, and a second antenna 129 that is not spatially orthogonal to the first antenna 128.

An information signal generated by the information signal generating circuit 123 is mixed with a carrier generated by the carrier frequency generating circuit 121 and up-converted by the first transmission mixer 124 and the signal is then branched into two paths. Branched signals pass through the first variable phase shifter 161 and the second variable phase shifter 162 respectively and radiated into space via the first antenna 128 and the second antenna 129.

The order of phase change of the first variable phase shifter 161 and the second variable phase shifter 162 is equal to the order of the period of the carrier frequency f_{c}. The present transmitter is capable of varying a relative phase that is a physical parameter of electromagnetic waves according to physical parameter information that is given from the controller 10.

Because, the carrier frequency order is typically higher than the order of frequency of information signals, it is reasonable to think that there is only a carrier phase difference in electromagnetic waves that are radiated from both antennas. Depending on the phases of the first variable phase shifter 161 and the second variable phase shifter 162, there occurs a carrier phase difference in radio waves that are radiated from the first antenna 128 and the second antenna 129. The resulting phase difference varies the directivity of transmission radio waves. By thus varying the transmission directivity distribution among multiple radio units for communication comprised in the radio system, it is enabled to restrain variation of the radio wave environment caused by movement of physical entities in the radio wave environment within the communication service area. This provides an advantageous effect for stabilizing communication performance of the radio system. The present invention is also applicable to communication using rotating polarization, besides ordinary telecommunications.

### Fourteenth Embodiment

A fourteenth embodiment is described with FIG. 22. In the present embodiment, descriptions are provided of operation of transmitter circuitry of a radio unit for communication to modify physical parameters of electromagnetic waves that are used for communication.

FIG. 22 is another example of a configuration diagram of a transmitter for use in the radio system. The transmitter 221-4 is equipped with an information signal generating circuit 123, a carrier frequency generating circuit 121, a first transmission mixer 124, a first variable phase shifter 161, a second variable phase shifter 162, a first variable power amplifier 163, a second variable power amplifier 164, a first antenna 128, and a second antenna 129 that is not spatially orthogonal to the first antenna 128.

An information signal generated by the information signal generating circuit 123 is mixed with a carrier generated by the carrier frequency generating circuit 121 and up-converted by the first transmission mixer 124 and the signal is then branched into two paths. Branched signals pass through the first variable phase shifter 161 and the second variable phase shifter 162 respectively and, after their power is weighted by the first variable power amplifier 163 and the second variable power amplifier 164, the signals are radiated into space via the first antenna 128 and the second antenna 129.

As with the embodiment of FIG. 21, the transmitter of the present embodiment is capable of varying the directivity of transmission radio waves and, moreover, enables it to control and precisely adjust variation of the directivity by using two parameters, i.e., amplitude and phase that are physical parameters of electromagnetic waves. The present embodiment can enhance the function of stabilizing communication performance of the radio system, as compared with the embodiment of FIG. 21.

### Fifteenth Embodiment

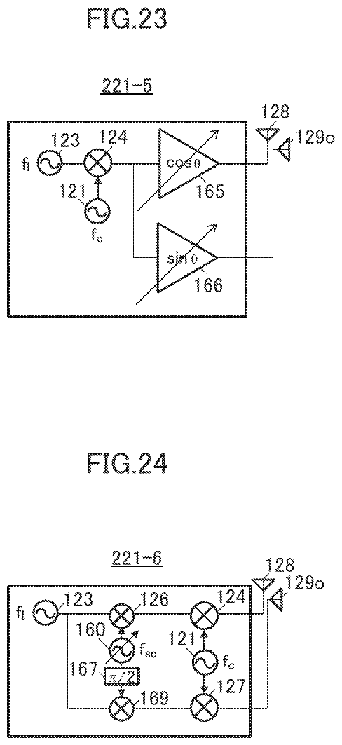

A fifteenth embodiment is described with FIG. 23. In the present embodiment, descriptions are provided of operation of transmitter circuitry of a radio unit for communication to modify physical parameters of electromagnetic waves that are used for communication. FIG. 23 is another example of a configuration diagram of a transmitter for use in the radio system where communication using rotating polarization is performed.

The transmitter 221-5 is equipped with an information signal generating circuit 123, a carrier frequency generating circuit 121, a first transmission mixer 124, a cosine amplitude weighting circuit 165, a sine amplitude weighting circuit 166, a first antenna 128, and a second antenna 1290 that is spatially orthogonal to the first antenna 128.

An information signal generated by the information signal generating circuit 123 is mixed with a carrier generated by the carrier frequency generating circuit 121 and up-converted by the first transmission mixer 124 and the signal is then branched into two paths. After the amplitude of branched signals is weighted by the cosine amplitude weighting circuit 165 and the sine amplitude weighting circuit 166 respectively, the signals are radiated into space via the first antenna 128 and the second antenna 129o. The transmitter of the present embodiment is capable of varying a polarization plane angle of transmission radio waves that is a physical parameter of electromagnetic waves.

Upon reflection and transmission of electromagnetic waves, occurring by hitting structural objects and objects existing in a radio communication service area, the polarization of the electromagnetic waves is made varied and matching between transmit and receive polarizations, which is a requirement for achieving good communication quality, becomes unmaintainable. By varying the polarization of transmission radio waves, matching can be made between transmit and receive polarizations.

By varying the polarization of transmission radio waves of multiple radio units for communication comprised in the radio system, the present embodiment enables it to restrain variation of the radio wave environment caused by movement of physical entities in the radio wave environment within the communication service area. This provides an advantageous effect for stabilizing communication performance of the radio system.

### Sixteenth Embodiment

A sixteenth embodiment is described with FIG. 24. In the present embodiment, descriptions are provided of operation of transmitter circuitry of a radio unit for communication to modify physical parameters of electromagnetic waves that are used for communication; the foregoing operation is applicable to previously described embodiments.

FIG. 24 is an example of a configuration a transmitter for use in the radio system where communication using rotating polarization is performed. The transmitter 221-6 is equipped with an information signal generating circuit 123, a carrier frequency generating circuit 121, a first transmission mixer 124, a second transmission mixer 127, a third transmission mixer 126, a fourth transmission mixer 169, a variable rotating polarization frequency generating circuit 160, a rotating polarization frequency band 90-degree phase shifter 167, a first antenna 128, and a second antenna 1290 that is spatially orthogonal to the first antenna 128.

An information signal generated by the information signal generating circuit 123 is branched into two paths. Branched signals are mixed with a carrier generated by the carrier frequency generating circuit 121 and up-converted by the first transmission mixer 124 and the second transmission mixer 127 respectively and then radiated into space via the first antenna 128 and the second antenna 129o.

In the present embodiment, the polarization of transmission radio waves is made to rotate at a rotating polarization frequency f_{sc} by the third transmission mixer 126, the fourth transmission mixer 129, the variable rotating polarization frequency generating circuit 160, and the rotating polarization frequency band 90-degree phase shifter 167.

Dimensions of objects that may exist in a radio communication service area are generally on the order of meters; therefore, the transmitter should use the rotating polarization frequency f_{sc} with a wavelength on the order equivalent to this order of dimensions. By varying the rotating polarization with the frequency f_{sc} and by thus varying the distribution of the rotating polarization frequency among multiple radio units for communication comprised in the radio system, it is enabled to restrain variation of the radio wave environment caused by movement of physical entities in the radio wave environment within the communication service area. This provides an advantageous effect for stabilizing communication performance of the radio system.

### Seventeenth Embodiment

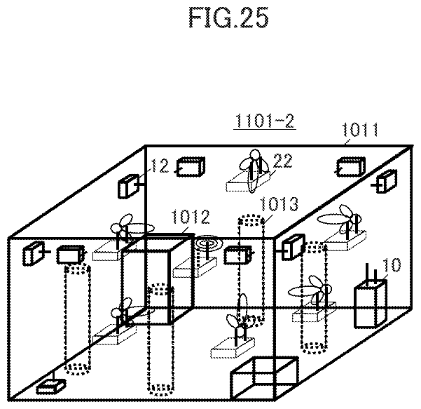

A seventeenth embodiment is described with FIG. 25. An IoT radio monitoring system 1101-2 of the present embodiment is equipped with multiple radio units 12 for measurement, multiple radio units 22 for communication, and a controller 10 inside a building 1011 in which multiple stationary structural objects 1012 and mobile objects 1013 exist.

By varying the distribution of directivity of transmission radio waves among multiple radio units 22 for communication comprised in the radio system, it is enabled to restrain variation of the radio wave environment caused by movement of physical entities in the radio wave environment within the communication service area. This provides an advantageous effect for stabilizing communication performance of the IoT radio monitoring system. According to the present embodiment, it is possible to realize an IoT radio monitoring system such that stable communication performance can be maintained, not depending on change of structural objects and mobile objects in the service area.

### Eighteenth Embodiment

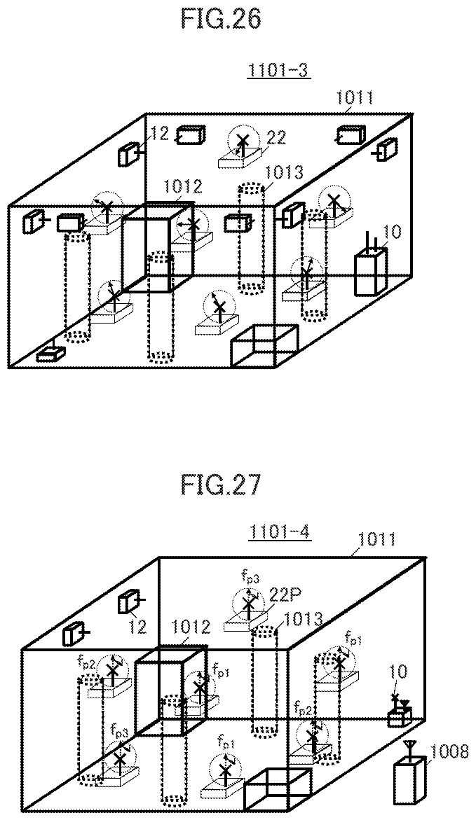

An eighteenth embodiment is described with FIG. 26. An IoT radio monitoring system 1101-3 of the present embodiment is equipped with multiple radio units 12 for measurement, multiple radio units 22 for communication, and a controller 10 inside a building 1011 in which multiple stationary structural objects 1012 and mobile objects 1013 exist.

According to configurations described previously, by varying the distribution of polarization of transmission radio waves among multiple radio units 22 for communication comprised in the radio system, it is enabled to restrain variation of the radio wave environment caused by movement of physical entities in the radio wave environment within the communication service area. This provides an advantageous effect for stabilizing communication performance of the IoT radio monitoring system. According to the present embodiment, it is possible to realize an IoT radio monitoring system such that stable communication performance can be maintained, not depending on change of structural objects and mobile objects in the service area.

### Nineteenth Embodiment

A nineteenth embodiment is described with FIG. 27. An IoT radio monitoring system 1101-4 of the present embodiment is equipped with multiple radio units 12 for measurement, multiple radio units 22P for communication using rotating polarization, a controller 10, and a server 1008 inside a building 1011 in which multiple stationary structural objects 1012 and mobile objects 1013 exist.

According to configurations described previously, by varying the distribution of the rotating polarization frequency among multiple radio units 22P for communication using rotating polarization comprised in the radio system, it is enabled to restrain variation of the radio wave environment caused by movement of physical entities in the radio wave environment within the communication service area. According to the present embodiment, it is possible to realize an IoT radio monitoring system such that stable communication performance can be maintained, not depending on change of structural objects and mobile objects in the service area.

For instance, a radio communication system may in some cases be designed in the following manner: after making a basic design assuming that the communication environment is free of uncertainty factors (behavior of mobile objects and atmospheric fluctuation), the system is tailored by adding certain margins to received signal quality such as electric field strength of received signals measured across the system to absorb uncertainty factors. According to the embodiments described hereinbefore, it is possible to vary radio unit performance dynamically, following dynamic variation of the radio environment attributed to uncertainty factors. Therefore, it is possible to compress the above margins for a radio system designed on the assumption of a static environment; this is effective for system cost reduction.

What is claimed is:

1. A radio communications method adapted to control physical characteristics of electromagnetic waves that are transmitted by radio units, the radio communications method comprising:
creating an electromagnetic field model for presuming a communication environment in a service area where the radio units exist by using information on positions and dimensions of objects in the service area;
presuming communication characteristics of the radio units through the electromagnetic field model; and
modifying the physical characteristics based on the communication characteristics and carrying out communication.

2. The radio communications method according to claim 1, wherein the information on positions and dimensions of objects includes information obtained by measuring information relevant to change in the positions and dimensions of the objects through measurement by radar principles.

3. The radio communications method according to claim 1, wherein the information on positions and dimensions of objects includes information obtained by measuring information relevant to change in the positions and dimensions of the objects through measurement of change of the plane of polarization of radio waves received.

4. The radio communications method according to claim 1, wherein the information on positions and dimensions of objects includes information obtained through measurement by radar principles or measurement of change of the plane of polarization of radio waves received and information recorded with respect to the objects in a database.

5. The radio communications method according to claim 2, further comprising:
accumulating historical data of information relevant to communication characteristics measured at the radio units;
deciding whether it is necessary to modify the physical characteristics based on change in the communication characteristics;
presuming how the communication characteristics of the radio units will behave by modifying the physical characteristics through the electromagnetic field model; and
modifying the physical characteristics of the radio units based on a result of the presumption about the communication characteristics.

6. A radio communications system comprising multiple radio units for communication and a controller,
the controller comprising:
a radio unit position storage unit to store the positions of the radio units for communication;
a measurement data storage unit to store measurement data relevant to change in positions and dimensions of objects in a service area where the radio units for communication exist;
a structural object data storage unit in which structural object data has been stored with regard to information on positions and dimensions of objects in the service area where the radio units for communication exist;
a radio wave environment computation unit that creates a model for computing a radio wave environment in the service area, based on the positions of the radio units for communication, the measurement data, and the structural object data; and
a physical parameter computation unit that computes physical parameters so that the radio wave environment approximates to a predetermined target value, based on the radio wave environment,
wherein:
the controller transmits the physical parameters to the radio units for communication; and
the radio units for communication modify transmission conditions based on the received physical parameters.

7. The radio communications system according to claim 6, wherein the structural object data further includes information relevant to material of the objects in the service area.

8. The radio communications system according to claim 6, further comprising multiple radio units for measurement,
wherein the measurement data measured by the radio units for measurement is transmitted from the radio units for measurement to the controller.

9. The radio communications system according to claim 6,
wherein the transmission conditions are modified by varying transmission power of the radio units for communication.

10. The radio communications system according to claim 6,
wherein the transmission conditions are modified by varying a polarization angle of electromagnetic waves that are transmitted by the radio units for communication.

11. The radio communications system according to claim 6,
wherein the transmission conditions are modified by varying a propagation frequency of electromagnetic waves that are transmitted by the radio units for communication.

12. The radio communications system according to claim 6,
wherein the transmission conditions are modified by varying transmission directivity of the radio units for communication.

13. The radio communications system according to claim 6,
wherein:
the radio units for communication are radio units using rotating polarization;
the measurement data is information on polarization of the radio units using rotating polarization; and
the transmission conditions are modified by varying a polarization state of rotating polarization waves that are transmitted by the radio units for communication.

14. The radio communications system according to claim 13, wherein transmission/reception timing of the radio units using rotating polarization is varied.

15. The radio communications system according to claim 13, wherein a rotating polarization frequency of the radio units using rotating polarization is varied.
